(19) United States
(12) Patent Application Publication
(10) Pub. No.: US 2009/0119005 A1
(43) Pub. Date: May 7, 2009

(54) Navigation control device, navigation equipment, server and destination setting system

(75) Inventors: Isao Ishibashi, Kobe-shi (JP); Teru Sawada, Kobe-shi (JP)

Correspondence Address: OLIFF & BERRIDGE, PLC, P.O. BOX 320850, ALEXANDRIA, VA, 22320-4850, US

(73) Assignee: FUJITSU TEN LIMITED, KOBE-SHI (JP)

(21) Appl. No.: 12/285,761

(22) Filed: Oct. 14, 2008

(30) Foreign Application Priority Data
Oct. 16, 2007 (JP) 2007-269311
Sep. 30, 2008 (JP) 2008-253443

(51) Int. Cl. G01C 21/36

(52) U.S. Cl. 701/201; 701/207

(57) ABSTRACT

A navigation control device, which is mounted in navigation equipment searching for a route and sets a destination from plural pieces of position information forwarded, includes: accepting portion accepting the plural pieces of position information forwarded from the mobile terminal; present position information acquiring portion acquiring present position information about a present position of the navigation equipment; sequencing portion comparing the present position information acquired by the present position information acquiring portion with the plural pieces of position information accepted by the accepting portion, and sequencing the plural pieces of position information on the basis of a distance from the present position to a destination; and destination setting portion setting the destination on the basis of the position information sequenced by the sequencing portion.

### BACKGROUND OF THE INVENTION

The present invention relates to a navigation control device, navigation equipment, a server and a destination setting system.

Conventional navigation equipment mounted in a vehicle has a problem that an operation of setting a destination entails directly inputting information such as an address, a name and a telephone number from an operation unit, which is inconvenient. A known technology for obviating this kind of problem is a technology disclosed in, e.g., Patent document 1. Patent document 1 discloses the technology of transmitting position information stored in an information storage portion of a mobile terminal to the navigation equipment through infrared-ray communications.

[Patent document 1] Japanese Patent Laid-Open Publication No. 2002-22468

### SUMMARY OF THE INVENTION

The known technology is that the position information stored in the information storage portion of the mobile terminal is transmitted to the navigation equipment via a transmitting portion such as infrared-ray communications. According to this technology, for example, the navigation equipment can perform a route guidance utilizing the position information searched by the mobile terminal.

On the other hand, there are known such commercial services using a vehicle as sales of a real estate dealer, a round of bottling and sales of insurance operations. Then, over the recent years, the vehicle mounted with the navigation equipment has been increasingly used for these commercial services. It is therefore considered that utilization of the technology given above enables the operations of those commercial services to be made more efficient. Note that according to the technology described above, one piece or plural pieces of position information can be transmitted to the navigation equipment from the mobile terminal. For example, the sales of the real estate dealer involve a case of utilizing the navigation equipment for the commercial services such as introducing a plurality of properties at one time to a customer, in which case it is more convenient that the plural pieces of position information can be registered at one time. Further, when simply transmitting the plural pieces of position information to the navigation equipment, a matter of concern is such an unacceptable degree of convenience that the navigation equipment must sequence the plural pieces of position information in order to specify where the person in charge of sales of the real estate dealer should visit.

It is an object of the present invention, which was devised in view of the problems described above, to enhance the convenience by reducing an operation burden on a user in a technology of forwarding plural pieces of position information to navigation equipment by use of a mobile terminal.

### MEANS FOR SOLVING THE PROBLEMS

According to the present invention, for accomplishing the object described above, plural pieces of position information forwarded from a mobile terminal are sequenced, and a destination is set based on the plural pieces of thus-sequenced position information.

Specifically, the present invention is a navigation control device, which is mounted in navigation equipment searching for a route and sets a destination from plural pieces of position information forwarded from a mobile terminal, the navigation control device comprising: accepting portion accepting the plural pieces of position information forwarded from the mobile terminal; present position information acquiring portion acquiring present position information about a present position of the navigation equipment; sequencing portion comparing the present position information acquired by the present position information acquiring portion with the plural pieces of position information accepted by the accepting portion, and sequencing the plural pieces of position information on the basis of predetermined conditions including at least any one of a distance from the present position to a destination and time taken from the present position to the destination; and destination setting portion setting the destination on the basis of the position information sequenced by the sequencing portion.

According to the present invention, the plural pieces of position information from the mobile terminal can be accepted, and hence it is feasible to obviate a time-consuming operation of setting the destination each time. Further, according to the present invention, the plural pieces of accepted position information are compared with the present position information, and the destination is set based on the plural pieces of position information sequenced based on the predetermined conditions, thereby making it feasible to obviate such a time-consuming operation that a user himself or herself sequences the information. Namely, the operation burden on the user can be reduced. Moreover, navigation equipment incorporating the present invention is mounted in a vehicle used for commercial services employing the vehicle such as sales of a real estate dealer, a round of bottling and sales of insurance operations, in which case the plural pieces of position information are forwarded at one time to the navigation equipment, and the destination is set after the forwarded position information has been sequenced based on the distance information, whereby the operations can be made more efficient.

The plural pieces of position information forwarded from the mobile terminal can be accumulated in the way of being associated with the information managed by the server. The plural pieces of position information can be described in a mail and thus transmitted, and the plural pieces of position information described in the transmitted mail are forwarded to the navigation equipment from the mobile terminal, whereby the destination can be set. Namely, the navigation control device of the present invention is employed together with the mobile terminal communicable with the navigation equipment mounted with the navigation control device and together with a server transmitting the mail to the mobile terminal, thereby exhibiting more excellent performance. Such being the case, at first, the server and the mobile terminal will be explained.

The server can take a configuration including storage portion containing information with which the position information is previously associated; extracting portion extracting plural pieces of predetermined information from the information contained in the storage portion; and mail transmitting portion describing the plural pieces of predetermined information extracted therefrom in a mail and thus transmitting the mail.

The “information previously associated with the position information” connotes property information, shop information, etc associated with the longitude/latitude information as the position information. The extraction by the extracting portion can be conducted by the server on the basis of the predetermined search conditions such as local information, time information and distance information. The phrase “the plural pieces of position information can be described in a mail and thus transmitted” implies that the position information specifying locations of the property and the shop is described together with the property information and the shop information in the mail and thus transmitted. According to the present invention, the plural pieces of position information can be simultaneously transmitted to the mobile terminal by utilizing the mail.

The mobile terminal can take a configuration including: receiving portion receiving the mail transmitted by the mail transmitting portion; and forwarding portion forwarding, to the navigation equipment, plural pieces of position information associated with the plural pieces of information described in the mail received by the receiving portion. This configuration enables simultaneous forwarding of the plural pieces of position information described in the mail transmitted from the server to the navigation equipment.

Next, each of components of the navigation control unit of the present invention will be described. The accepting portion accepts the plural pieces of position information forwarded from the mobile terminal. The position information can be forwarded from the mobile terminal through, e.g., infrared-ray communications. The forwarding portion is not, however, limited to the infrared-ray communications. It may be sufficient to establish an electric connection, and either a wireless connection or a cable connection may also be adopted.

The present position information acquiring portion acquires the present position information of the navigation equipment mounted with the navigation control device of the present invention. The acquisition of the present position may involve utilizing, e.g., a GPS (Global Positioning System) function installed into the conventional navigation equipment.

The sequencing portion sequences the plural pieces of position information transmitted from the mobile terminal. More specifically, the sequencing portion compares the present position information acquired by the present position information acquiring portion with the plural pieces of position information accepted by the accepting portion, and sequences the plural pieces of position information on the basis of predetermined conditions containing at least any one of a distance from the present position to a destination and time taken from the present position to the destination. Calculations of the distance from the present position to the destination and the time taken from the present position to the destination can involve properly using a technology of the conventional navigation equipment. Note that the distance and the time taken from the present position to one destination differ depending on a guidance route. Namely, the distance and the time taken from the present position to a certain destination differ depending on search conditions (e.g., depending on whether a superhighway is utilized or not and so forth). Accordingly, in the case of further calculating a plurality of guidance routes for every destination, for instance, a preferable scheme is that each optimum guidance route is selected after unifying the search conditions such as whether the superhighway is utilized or not, and the distances and the periods of required time along the selected optimum guidance routes are compared with each other. This scheme enables the accurate comparison and the accurate sequencing to be attained.

The destination setting portion sets the destination on the basis of the plural pieces of position information sequenced by the sequencing portion. For example, in the case of sequencing the position information based on the distance from the present position to the destination and in the order from the shortest distance, it follows that the destination showing the shortest distance from the present position to the destination is set as a first destination.

Herein, according to the present invention, the navigation control unit may further include: traffic jam information acquiring portion acquiring traffic jam information; and traffic jam information storage portion stored with the traffic jam information acquired by the traffic jam information acquiring portion, wherein the sequencing portion may sequences the plural pieces of position information in a way that takes account of the real-time traffic jam information acquired by the traffic jam information acquiring portion and the traffic jam information stored in the traffic jam information storage portion.

The traffic jam information acquiring portion acquires the traffic jam information. The traffic jam information may be acquired by utilizing, e.g., a VICS (Vehicle Information and Communication System) function installed into the conventional navigation equipment. On the occasion of sequencing, the position information can be sequenced more properly by taking the traffic jam information into consideration. Herein, for example, in the case of acquiring the traffic jam information by utilizing the VICS, as for the real-time traffic jam information, an error such as occurrence of a time lag might be caused between an actual congestion state and the acquired traffic jam information. Such being the case, according to the present invention, the sequencing process takes account of past traffic jam information in addition to the real-time traffic jam information. The traffic jam information storage portion is stored with the traffic jam information acquired by the traffic jam information acquiring portion. For example, the traffic jam information storage portion is stored with the congestion state of every guidance route in a way that sorts the congestion states according to the days of week and time zones. The congestion states may be stored stepwise such as being crowded and smooth. The position information can be sequenced more adequately by taking account of the past traffic jam information stored in this type of traffic jam information storage portion.

Herein, the present invention may also be navigation equipment mounted with the navigation control device. Specifically, the present invention is a navigation equipment comprising: a navigation control unit setting a destination from plural pieces of position information forwarded from a mobile terminal; and a display unit displaying a route up to a destination set by the navigation control unit, the navigation control unit including: accepting portion accepting the plural pieces of position information forwarded from the mobile terminal; present position information acquiring portion acquiring present position information about a present position of the navigation equipment; sequencing portion comparing the present position information acquired by the present position information acquiring portion with the plural pieces of position information accepted by the accepting portion, and sequencing the plural pieces of position information on the basis of predetermined conditions including at least any one of a distance from the present position to a destination and time taken from the present position to the destination; and destination setting portion setting the destination on the basis of the position information sequenced by the sequencing portion.

Moreover, the present invention may also be a destination setting system comprising the navigation equipment, the mobile terminal and the server described above. The navigation equipment, the mobile terminal and the server described above are made to function as one single system, whereby it is feasible to improve efficiency of operations in commercial services using a vehicle such as sales of a real estate dealer, a round of bottling and sales of insurance operations.

Herein, in the mode described above, the sequencing process is done on the side of the navigation equipment, however, for example, it is considered that a time lag occurs in the VICS, and there is a case in which the server rather than the navigation equipment can acquire real-time information. Such being the case, according to a mode different from the modes described above, when transmitting the plural pieces of position information to the mobile terminal, the position information may also be sequenced on the side of the server. More specifically, the present invention is a destination setting system setting a destination of navigation equipment by forwarding position information contained in information managed by a server to the navigation equipment via a mobile terminal, the server including: server-sided position information acquiring portion acquiring plural pieces of position information for setting a destination of the navigation equipment; server-sided sequencing portion sequencing the plural pieces of position information acquired by the server-sided position information acquiring portion; and mail transmitting portion describing the plural pieces of position information sequenced by the sequencing portion in a mail and thus transmitting the mail to the mobile terminal. Then, the mobile terminal includes receiving portion receiving the mail transmitted by the mail transmitting portion, and forwarding portion forwarding the plural pieces of position information described in the mail by the receiving portion to the navigation equipment. Further, the navigation equipment includes a navigation control unit setting the destination from the plural pieces of position information forwarded from the mobile terminal, and a display unit displaying a route up to the destination set by the navigation control unit. Still further, the navigation control unit includes accepting portion accepting the plural pieces of position information forwarded from the mobile terminal, and destination setting portion setting the destination on the basis of the plural pieces of position information accepted by the accepting portion and sequence by the server.

According to the present invention, the plural pieces of position information can be sequenced on the side of the server. The plural pieces of sequenced position information can be acquired from, e.g., another computer. Another computer can be exemplified by a computer installed at a business office etc in the case of a corporation and by a computer installed at a home etc in the case of an individual. Moreover, another computer may also be the mobile terminal. The server-sided position information acquiring portion can acquire the plural pieces of position information in such a way that the plural pieces of position information are described in the mails etc, and the mails are sent to the server from those computers. Further, the plural pieces of position information to be sequenced may also be the plural pieces of position information accepted by the accepting portion of the navigation equipment described above.

The server-sided sequencing portion sequences the acquired position information. The position information can be sequenced based on, for example, sequencing reference information containing at least one of traffic jam information acquired by the server and required time information taken up to the destination. Note that the mail transmitting portion of the server, the receiving portion and the forwarding portion of the mobile terminal, and the navigation control unit and the display unit of the navigation equipment fundamentally have the same configurations as those in the mode of executing the sequencing process on the side of the navigation equipment, and hence their explanations are omitted.

Herein, the server-sided sequence changing portion may, when a query is given from the mobile terminal, again execute the sequencing process. Namely, the execution of the sequencing process may also be triggered by receiving the query from the mobile terminal. This scheme enables the sequencing process to be executed when the necessity arises. The time “when the necessity arises” is exemplified by a case in which a receiving state of the VICS of the navigation equipment declines.

Moreover, the position information may contain, in addition to the present position information about the present position and the destination information about the destination, via-location information about a via-location. With this scheme, it is feasible to set not only the destination but also the route up to the destination.

It should be noted that the present invention may be a server or navigation equipment, which build up the destination setting system described above. Moreover, the present invention may also be a method or a program for realizing processes executed by the navigation control device, the server and the mobile terminal. Still further, the present invention may also be a readable-by-computer recording medium recorded with such a program. In this case, the computer etc is made to read and execute the program on this recording medium, whereby the function thereof can be provided. Note that the recording medium readable by the computer etc connotes a recording medium capable of storing information such as data and programs electrically, magnetically, optically, mechanically or by chemical action, which can be read from the computer etc.

According to the present invention, the convenience can be enhanced by reducing the operation burden on the user in the technology of forwarding the plural pieces of position information to the navigation equipment via the mobile terminal.

### BRIEF DESCRIPTION OF THE DRAWINGS

FIG. 1 A view showing an outline of an architecture of a destination setting system.

FIG. 2 A diagram of function blocks of a server.

FIG. 3 A diagram showing one example of a database stored in a storage unit.

FIG. 4 A diagram of function blocks of a mobile terminal.

FIG. 5 A diagram showing one example of a display status of a mail transmitted to the mobile terminal from the server.

FIG. 6 A diagram showing one example of a Web page displayed on a display unit of the mobile terminal.

FIG. 7 A diagram an outline of a configuration of navigation equipment.

FIG. 8 A diagram of function blocks of a navigation control unit.

FIG. 9 A diagram showing one example of a database of traffic jam information.

FIG. 10 A flowchart showing a flow of processes executed in the destination setting system.

FIG. 11 A diagram showing a display status of a display of the navigation equipment.

FIG. 12 A view showing an outline of an architecture of the destination setting system in a second embodiment.

FIG. 13 A diagram showing a hardware configuration of the data processing device.

FIG. 14 A diagram showing a position information management screen for managing the position information organizing a round list.

FIG. 15 A diagram showing one example of the round list.

FIG. 16 A diagram of function blocks of the server according to the second embodiment.

FIG. 17 A flowchart showing a destination setting process according to the second embodiment.

FIG. 18 A diagram showing one example of a management screen on which the generated round list is described in a mail.

FIG. 19 A diagram showing one example of a template of the mail to be transmitted.

FIG. 20 A flowchart showing a flow of a sequencing process in the server in response to a request given from the mobile terminal.

FIG. 21 A diagram showing one example of a Web page displayed on a display unit of the mobile terminal which requests the server to perform sequencing.

FIG. 22 A diagram showing one example of a position information management screen for managing the position information organizing the round list.

### DETAILED DESCRIPTION OF THE INVENTION

Embodiments of a navigation control device, navigation equipment and a destination setting system according to the present invention will be described. Note that the following discussion will exemplify a case in which the destination setting system according to the present invention is applied to sales operations of a real estate dealer. Accordingly, a vehicle driven by a person in charge of sales of the real estate dealer is equipped with the navigation equipment mounted with the navigation control device according to the present invention.

### First Embodiment

<Architecture>

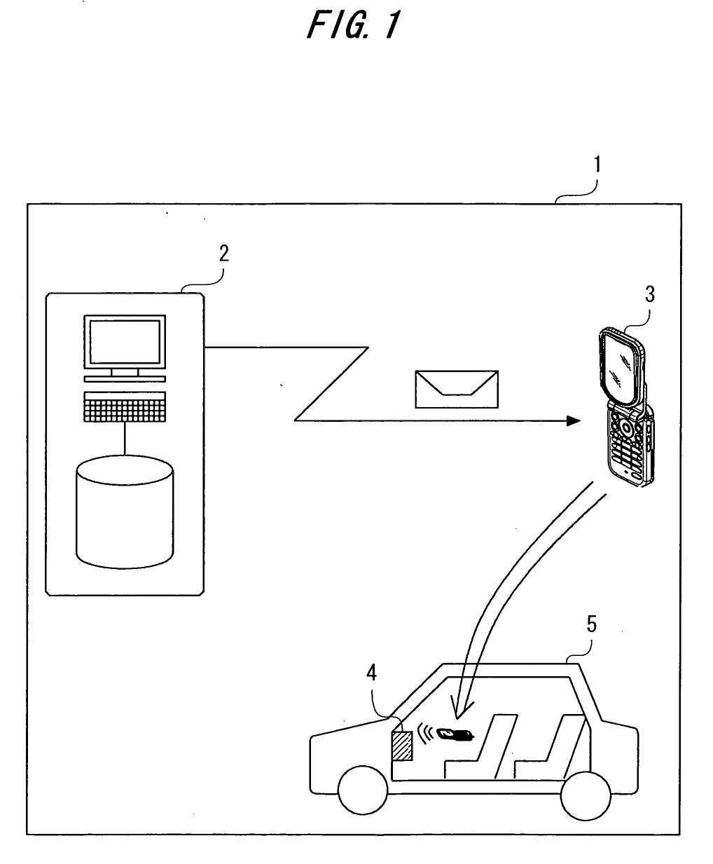

FIG. 1 shows an outline of an architecture of the destination setting system in a first embodiment. As illustrated in FIG. 1, a destination setting system 1 is configured by a server 2, a mobile terminal 3 and navigation equipment 4 mounted in a vehicle 5.

<Server>

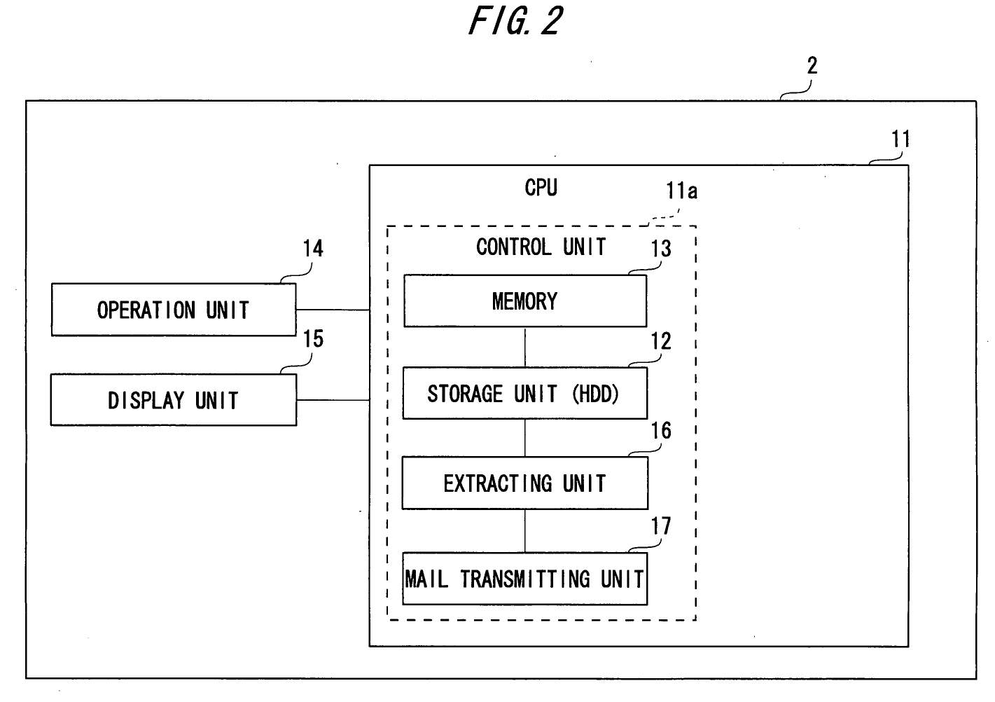

FIG. 2 shows a diagram of function blocks of the server 2. The server 2 includes a CPU (Central Processing Unit) 11, a control unit 11a, an operation unit 14 and a display unit 15. The control unit 11a includes a memory 13, a storage unit (hard disk drive) 12, an extraction unit 16 and a mail transmitting unit 17 that transmits a mail in which to describe a plurality of predetermined items of information extracted.

The CPU 11 is connected to hardware components such as the storage unit 12 via a bus, controls the hardware components such as the storage unit 12, and executes a predetermined process in accordance with a control program stored in a ROM (Read Only Memory) defined as, e.g., the memory 13.

The storage unit 12 can be built up by the hard disk drive. The memory 13 includes a volatile RAM (Random Access Memory) and a non-volatile ROM (Read Only Memory). The ROM includes a rewritable semiconductor memory such as an EPROM (Erasable Programmable Read-Only Memory) and an EEPROM (Electrically Erasable Programmable Read-Only Memory).

The operation unit 14 includes an input device such as a keyboard and a pointing device of a computer. The display unit 15 is exemplified by, e.g., a liquid crystal display device, a plasma display panel, a CRT (Cathode Ray Tube), an electroluminescence panel, etc.

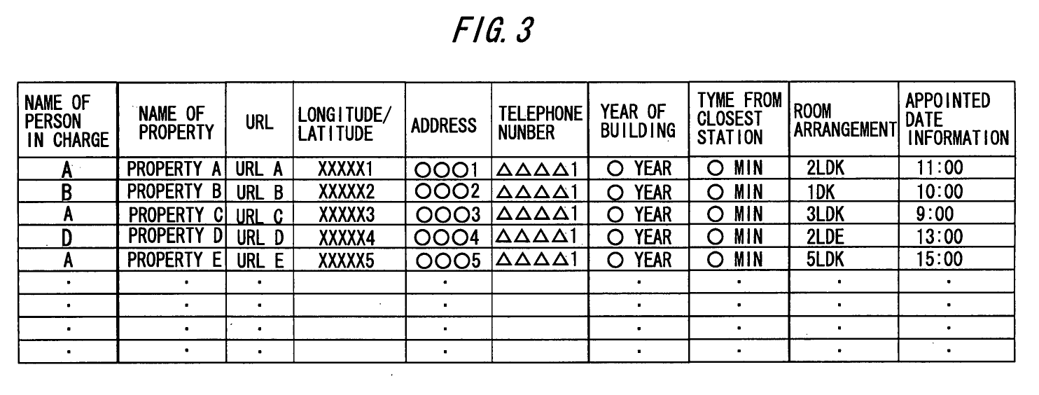

The storage unit 12 is stored with information associated with position information beforehand. Herein, FIG. 3 shows one example of a database stored in the storage unit 12. FIG. 3 shows the database for the sales operations for the real estate dealer, and the database is organized by fields such as a name of a person-in-charge, a name of a property, a URL (Uniform Resource Locator) per property, a longitude and a latitude, an address, a telephone number, years of building, the time taken from the closest station, room arrangement and appointed date information. The appointed date information represents the time of appointment for transferring and receiving a key between a landlord and a tenant, visiting time of a visitor who observes the property, and so on. Note that the destination setting system 1 according to the first embodiment is pre-equipped with a database for every commercial service such as a round of bottling and the sales for insurance operations, thereby providing flexibility to a variety of businesses.

The extraction unit 16 extracts the information about the property. defined as a destination from the items of information stored in the storage unit 12 on the basis of the search conditions (the address, the telephone number, the years of building, the time taken from the closest station, the room arrangement, etc) inputted by the person in charge of the sales of the real estate dealer or by an administrator who allocates the operations to the person in charge of the sales.

The mail transmitting unit 17 transmits a mail (an electronic mail) in which to describe plural items of extracted property information. A mail format is not particularly limited but may adopt any one of a text format and an HTML (HyperText Markup Language) format. The information described in the mail contains at least the position information (longitude/latitude) as the information for setting the destination in the navigation equipment 4 when forwarding the mail to the navigation equipment 4 from the mobile terminal 3. Further, it is impossible to pinpoint, simply based on the longitude and the latitude, where the position information specifies, and it is therefore preferable to describe the position information together with a name (e.g., the name of the property), the URL, etc. Moreover, there may be also described a command for enabling the longitude/latitude to be transmitted by clicking the URL in which the property information is managed on a person-by-person basis who is in charge of the sales and clicking a transmission button 29 attached to the transmitted mail. Note that other items of information (e.g., the years of building, the time taken from the closest station and the room arrangement) are displayed on the display unit 15 of the navigation equipment 4 and can be thereby utilized as an information source. Further, it is preferable to describe a command for forwarding plural pieces of position information described in the mail to the navigation equipment 4. This scheme enables the position information to be easily forwarded to the navigation equipment 4 from the mobile terminal 3. Namely, the mobile terminal 3 can forward the plural pieces of position information at one time without newly starting up an independent application program for forwarding the position information.

(Mobile Terminal)

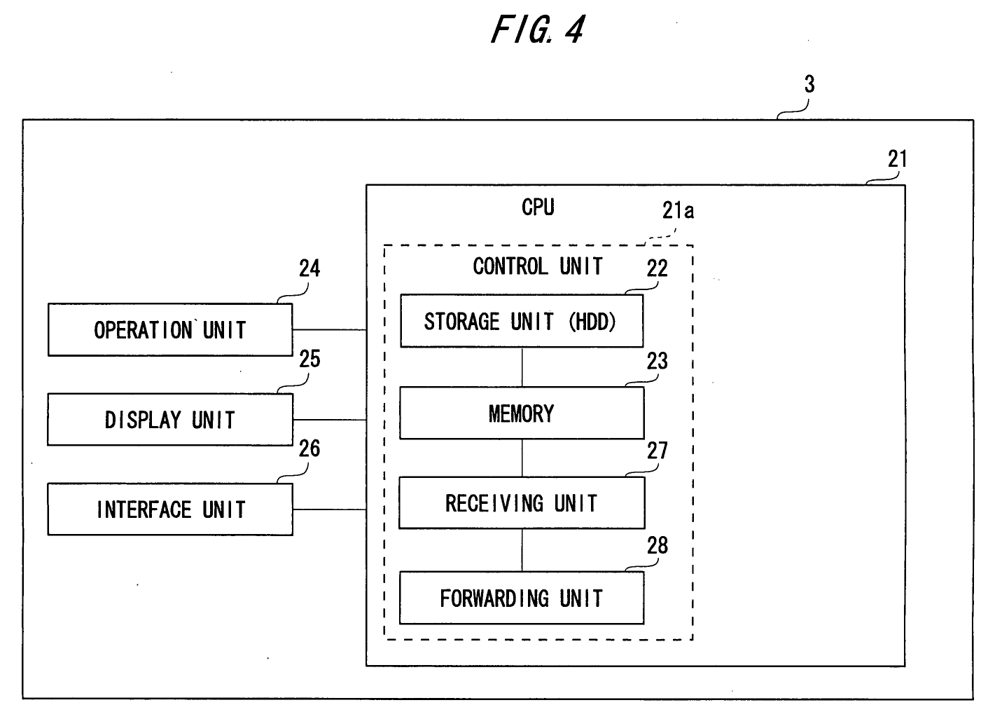

FIG. 4 shows a diagram of function blocks of the mobile terminal 3. As illustrated in FIG. 4, the mobile terminal 3 is constructed of a CPU (Central Processing Unit) 21, a control unit 21a, an operation unit 24, a display unit 25 and an interface unit 26 connectable to an external device. The control unit 21a of the mobile terminal 3 includes a memory 23, a receiving unit 27 and a forwarding unit 28.

The CPU 21, which is connected to hardware components such as the memory 23 via a bus 20, controls the hardware components such as the storage unit 22, and executes a predetermined process in accordance with a control program stored in a ROM (Read Only Memory) defined as, e.g., the memory 23. The memory 23 includes a volatile RAM and a nonvolatile ROM. The operation unit 24 is, it may be sufficient, a general type of operation buttons needed for operating the mobile terminal 3 and may take a touch display system. The interface unit 26 in the first embodiment is constructed of an infrared-ray port enabled to communicate with the navigation equipment 4. However, the interface unit 26 is, it may be sufficient, electrically connectable to the navigation equipment 4 irrespective of a cable connection and a wireless connection. The interface unit 26 may be a connector for connecting a cable and may also be a transmission unit for Bluetooth (registered trademark).

The memory 23 is stored with a variety of control programs necessary for the mobile terminal 3. Further, the memory 23 can be also temporarily stored with the plural pieces of position information transmitted from the server 2. The receiving unit 27 receives the mail transmitted from the server 2. Further, the forwarding unit 28 forwards the plural pieces of position information described in the mail received by the receiving unit 27 to the navigation equipment 4 through the infrared-ray communications. Note that the receiving unit 27 and the forwarding unit 28 can be configured as computer programs running on the CPU 21. Further, the receiving unit 27 and the forwarding unit 28 may also be configured as dedicated processors.

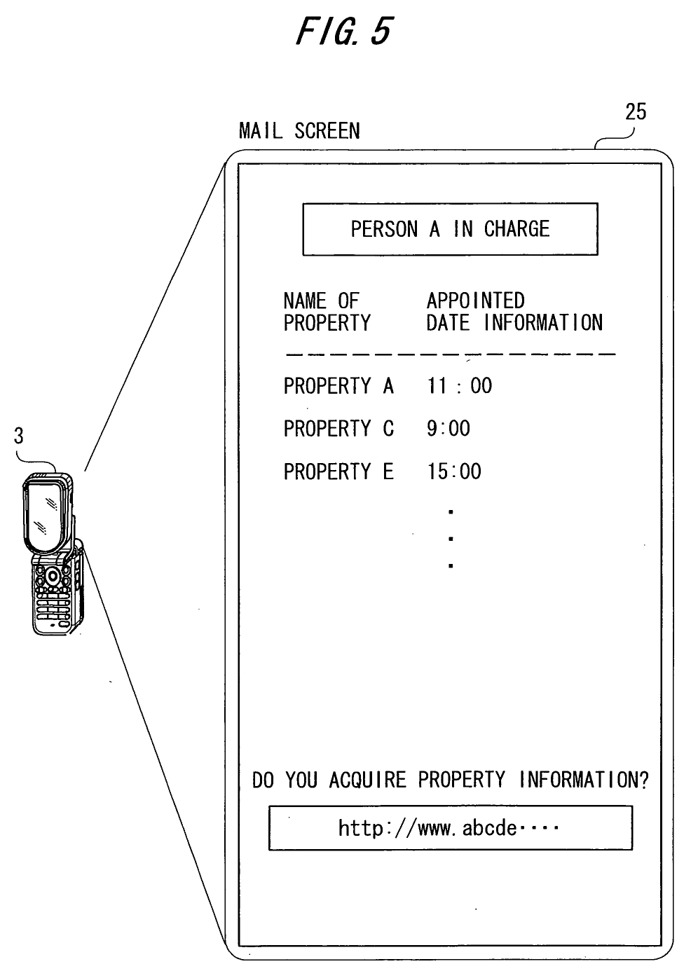

Herein, FIG. 5 shows one example of a display status of the mail transmitted from the server 2 to the mobile terminal 3 of the person in charge of sales. As shown in FIG. 5, the name of the property, the appointed date information per property, a comment saying [Do you acquire the property information?] and the URL information in which the property information is managed on the person-by-person basis who is in charge of sales, are displayed on the display unit 25 of the mobile terminal 3. Note that this type of mail is automatically transmitted by, e.g., the server 2 at the predetermined time (e.g., at 8 o'clock in every morning). The transmission time can be properly changed on the side of the server 2. Further, the mail may be transmitted not by the automatic transmission but by manually at the desired time the administrator who allocates the operations to the person in charge of sales.

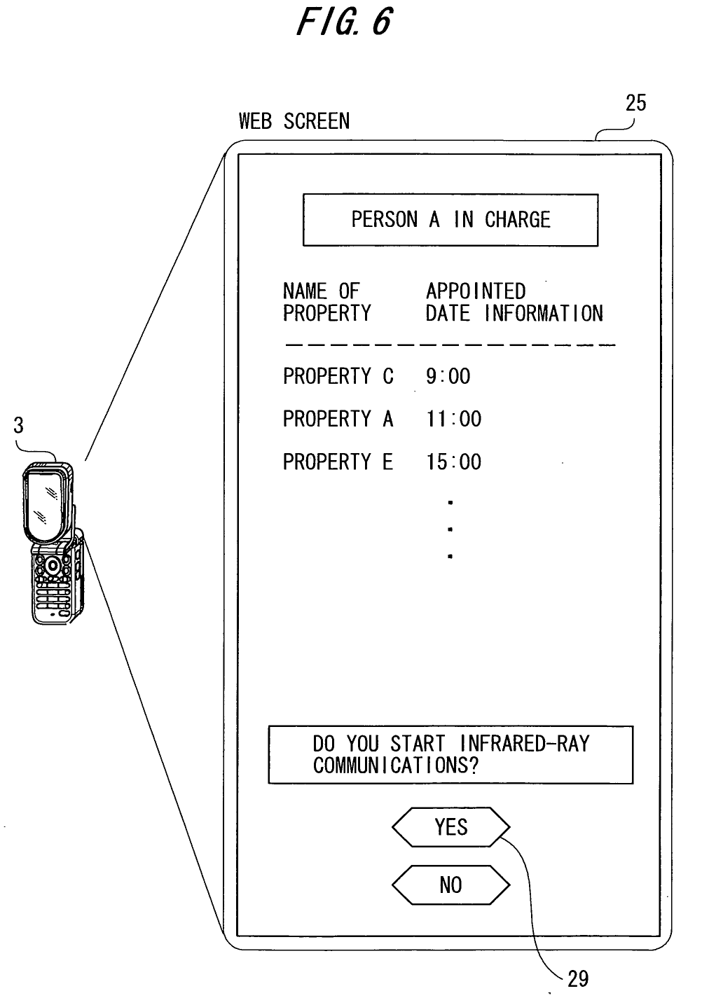

In the first embodiment, a shift to a Web page can be made by selecting the URL displayed on the display unit 25 of the mobile terminal 3 illustrated in FIG. 5. FIG. 6 shows one example of the Web page displayed on the display unit 25 of the mobile terminal 3 when the person in charge of sales selects the URL required for obtaining the property information covered by the person herself or himself in charge of sales. The property information, the appointed date information per property information, a comment saying [Do you start the infrared-ray communications?] and a transmission button 29 for executing the transmission of the position information associated with each item of property information, are displayed on the Web page illustrated in FIG. 6. Incidentally, on the Web page, the items of property information are rearranged in the sequence from the earliest appointed time on the basis of the appointed date information. The person in charge of sales of the real estate dealer checks the properties displayed on the Web page and can, if contents thereof are accepted, forward the plural pieces of position information simultaneously to the navigation equipment 4 by pressing the transmission button 29. Note that the navigation equipment 4 is required to previously enable the infrared-ray communications to be performed in order to make the position information acceptable from the mobile terminal 3.

Note that the person in charge of sales, when acquiring the property information covered by the same person herself or himself, selects a required URL and can, if a new piece of property information during a period till the Web page is displayed, display this new property information on the Web page. Moreover, the new property information can be also displayed on the Web page. Further, the property information can be rearranged in sequence via the operation unit of the mobile terminal 3.

(Navigation Equipment)

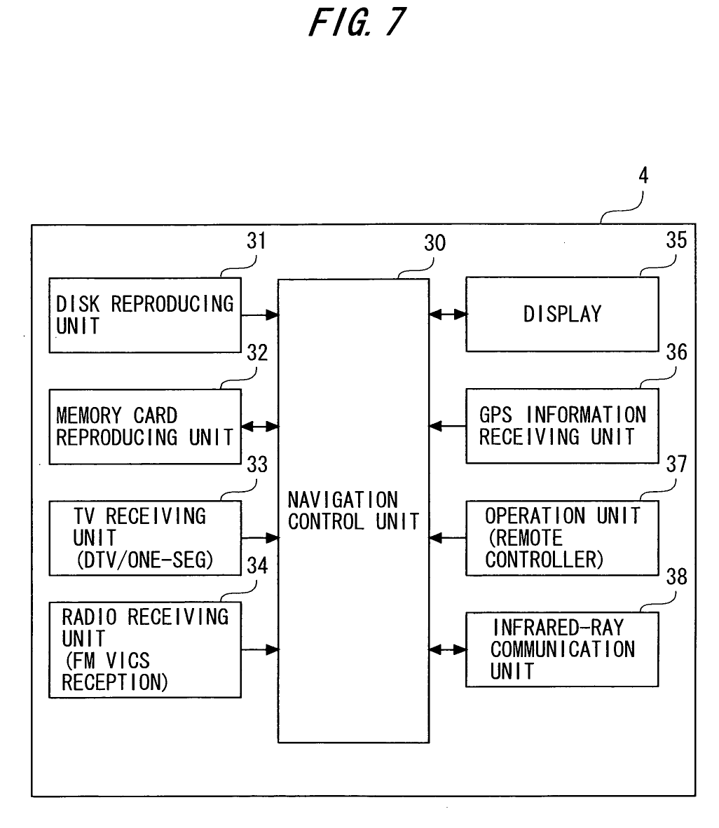

Next, the navigation equipment 4 mounted in the vehicle 5 will be explained. FIG. 7 shows an outline of a configuration of the navigation equipment 4. The navigation equipment 4 includes a disk reproducing unit 31, a memory card reproducing unit 32, a TV receiving unit 33, a radio receiving unit 34, a display 35, a GPS information receiving unit 36, an operation unit 37, an infrared-ray communication unit 38, and a navigation control unit 30 connected to these components.

The disk reproducing unit 31 reproduces content data recorded on an optical disk such as a CD, a DVD, etc. The disk reproducing unit 31 can be constructed of a CD/DVD deck. The memory card reproducing unit 32 reproduces the content data stored on a mobile storage medium detachably attachable to the navigation equipment 4, such as a USB (Universal Serial Bus) memory and an SD (Secure Digital) memory card. The TV receiving unit 33 receives a DTV (Digital Television) broadcast and a one-segment (1 seg) broadcast. The TV receiving unit 33 can be constructed of an existing tuner. The radio receiving unit 34 receives an FM broadcast, an AM broadcast, VICS (Vehicle Information and Communication System) information, etc. The radio receiving unit 34 can be constructed of an existing tuner. The display 35 displays various items of information (e.g., the years of building, the time taken from the closest station, the room arrangement) transferred together with the position information in addition to map information and a guidance route. It is preferable that the display 35 is of a touch panel type, however, multiple existing displays can be applied to the display 35. The GPS information receiving unit 36 receives the GPS information. The GPS information receiving unit 36 can be constructed of an existing GPS receiving antenna. The operation unit 37 transmits an electric signal corresponding to the operation button to the navigation control unit 30. The operation unit 37 may be provided in the navigation equipment 4 and may also be a remote controller enabling remote control to be done. The infrared-ray communication unit 38 receives the infrared rays output from the mobile terminal 3.

Incidentally, the navigation equipment 4 may be a portable navigation equipment demountable from the vehicle 5. In this case, the navigation equipment 4 may take a configuration having a built-in speaker and a built-in memory card in addition to the components described above. The speaker outputs a voice reproduced by the disk reproducing unit 31 and the memory card reproducing unit 32. The memory card is exemplified by the mobile storage medium such as the USB memory and the SD card.

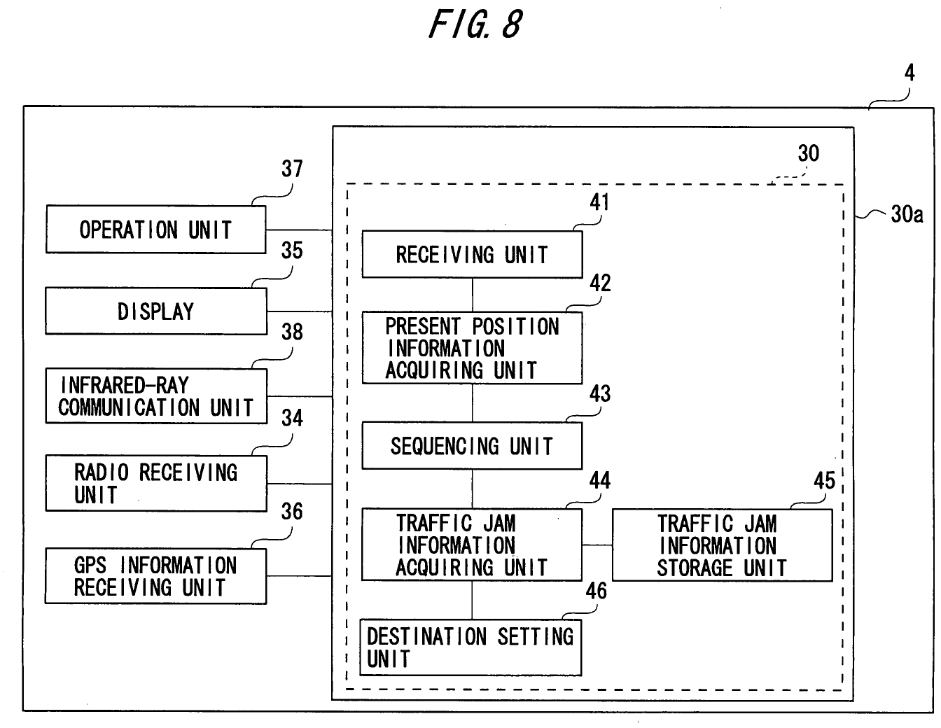

Next, the navigation control unit 30 mounted in the navigation equipment 4 will be described. FIG. 8 shows a diagram of function blocks of the navigation control unit 30. Note that the function block diagram shown in FIG. 8 omits an illustration of a control unit for controlling the disk reproducing unit 31 and the memory card reproducing unit 32 described above.

As illustrated in FIG. 8, the navigation control unit 30 includes an accepting unit 41, a present position information acquiring unit 42, a sequencing unit 43, a traffic jam information acquiring unit 44, a traffic jam information storage unit 45 and a destination setting unit 46. It is to be noted that the navigation control unit 30 can be realized by a computer including a CPU, a memory, etc and by a program running on the computer.

The accepting unit 41 accepts the plural pieces of position information (the longitude/latitude of each of properties A-E) through the infrared rays transmitted from the mobile terminal 3 and received by the infrared-ray communication unit 38 and the appointed date information per position information. Note that the accepting unit 41 can accept information other than the position information and the appointed date information. The present position information acquiring unit 42 acquires present position information about a present position of the navigation equipment 4 from the GPS information receiving unit 36. The sequencing unit 43, after giving the priority to the appointed date information, compares the present position information acquired by the present position information acquiring unit 42 with the position information (the longitude/latitude of each of properties A-E) about the plural pieces of property information accepted by the accepting unit 41, and sequences the position information on the basis of predetermined conditions containing at least any one of a distance from the present position to the destination and the necessary time from the present position to the destination. The destination setting unit 46 sets a first destination on the basis of the sequenced position information, the VICS information acquired by the traffic jam information acquiring unit 44 which will be described later on and the traffic jam information stored in the traffic jam information storage unit 45. Incidentally, a processing flow of the sequencing unit 43 will be explained later on.

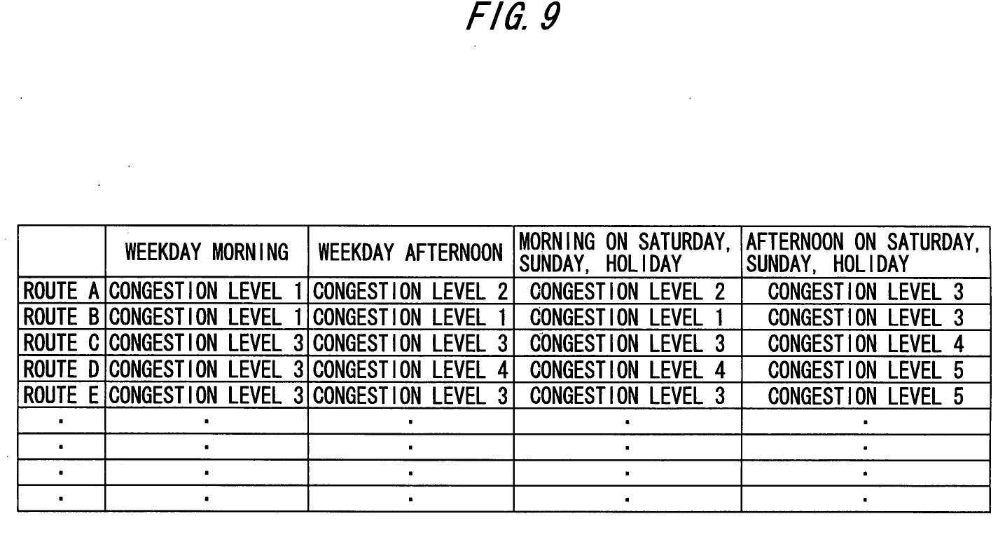

The traffic jam information acquiring unit 44 acquires the traffic jam information. Namely, the traffic jam information acquiring unit 44 acquires the VICS information received by the radio receiving unit 34. The traffic jam information storage unit 45 is stored with the traffic jam information acquired by the traffic jam information acquiring unit 44. Herein, FIG. 9 shows one example of a traffic jam information database. The database shown in FIG. 9 is structured in a way that expresses stepwise a crowded state of every guidance route (Route). Further, the crowded states are sorted according to time zones and days of the week. Incidentally, as to a congestion level, a level 5 represents the most crowded state. The thus-acquired traffic jam information is databased and taken into consideration when sequencing the position information, thereby enabling the position information to be sequenced more properly without being influenced by an error caused by a time lag when receiving the VICS information.

Note that the traffic jam information acquiring unit 44 includes the volatile RAM and the nonvolatile ROM. Further, in the navigation control unit 30, each of the receiving unit 41, the present position information acquiring unit 42, the sequencing unit 43 and the traffic jam information acquiring unit 44 can be configured as a computer program running on a CPU 30a. Moreover, these components may also be configured as dedicated processors.

<Processing Flow>

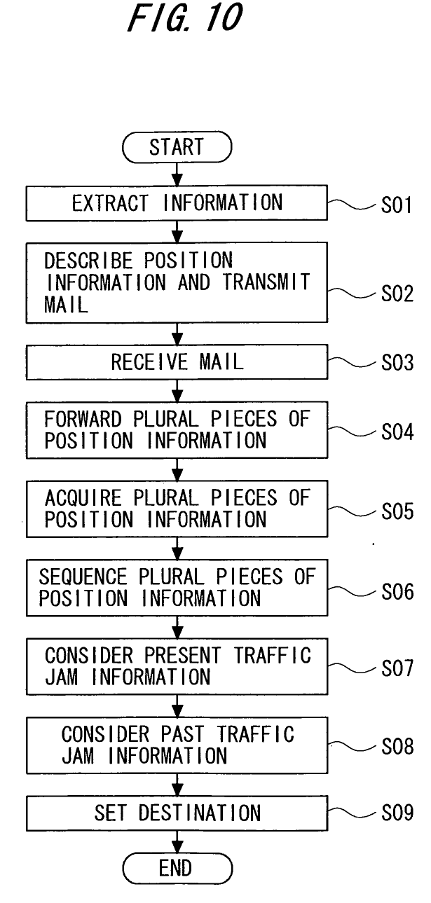

Next, a flow of a destination setting process executed by the destination setting system 1 according to the first embodiment will be described. FIG. 10 shows the flow of the destination setting process carried out by the destination setting system 1.

A start of the flow of the destination setting process is triggered by inputting a search condition from the operation unit 14 by the person in charge of sales of the real estate dealer or by the administrator who allocates the operations to the person in charge of sales. When the flow of the destination setting process is started by inputting the search condition from the operation unit 14, the extraction unit 16 extracts plural pieces of property information coincident with the search condition out of the pieces of property information stored in the storage unit 12 (see FIG. 3) (step S01). Upon completing the extraction of the property information, the operation proceeds to step S02.

The plural extracted pieces of predetermined property information (the information on the properties A-E in the first embodiment) are described in the mail (the e-mail), and the mail is transmitted (step S02). Namely, the mail transmitting unit 17 of the server 2 describes the longitude/latitude and the appointed date information of each of the properties A-E in the mail. In addition to the longitude/latitude, the mail transmitting unit 17 describes a command for enabling the longitude/latitude and the appointed date information to be transmitted by clicking the URL in which the property information is managed on the person-by-person basis who is in charge of the sales and clicking the transmission button 29 attached to the transmitted mail. Upon completing the description thereof in the mail, the longitude/latitude etc are transmitted to the mobile terminal 3. When completing the transmission of the mail, the operation proceeds to step S03.

Note that the server 2 automatically extracts the property information (the information on the properties A-E) according to the search condition and transmits the mail in which to describe the extracted property information in the first embodiment, however, for example, an available scheme is that the person (e.g., the administrator who allocates the operations to the person in charge of sales) accessible to the server 2 refers to the database, manually picks up the predetermined information, and transmits the mail containing the description of the picked-up information.

In step S03, the receiving unit 27 of the mobile terminal 3 receives the mail transmitted from the server 2. When accessing the URL displayed on the received mail screen, the Web page is displayed on the display unit 25 of the mobile terminal 3 (see FIG. 6). In next step S04, the plural pieces of position information displayed on the Web page are transferred to the navigation equipment 4 through the infrared-ray communications by clicking the transmission button 29 provided in the Web page. When the transfer of the position information to the navigation equipment 4 is completed, the operation proceeds to step S05. It is to be noted that the first embodiment takes the scheme of accessing once the URL in which the property information is managed on the person-by-person basis who is in charge of the sales and transferring the position information by clicking the transmission button 29 provided on the Web screen, however, another available scheme is that the mail transmitted from the server 2 is attached with the transmission button 29, and the position information is transferred directly from the mail screen.

In step S05, the accepting unit 41 of the navigation equipment 4 acquires the plural pieces of position information (the longitudes/latitudes of the properties A-E) and the appointed date information on a property-by-property basis through the infrared rays transmitted from the mobile terminal 3 and received by the infrared-ray communication unit 38. Upon completing the acquisition of the position information etc by the accepting unit 41 of the navigation equipment 4, the operation proceeds to step S06.

In step S06, after giving the priority to the appointed date information, the present position information acquired by the present position information acquiring unit 42 is compared with the plural pieces of position information accepted by the accepting unit 41, and the position information is sequenced based on the predetermined conditions. More specifically, the sequencing unit 43 compares the present position information (the longitude/latitude) received by the GPS information receiving unit 36 with the plural pieces of position information (the longitudes/latitudes of the properties A-E) acquired by the accepting unit 41, and sequences the compared information in the sequence from the shortest distance. For example, if a distance from the present position to the property B is the shortest, the property B is the first destination.

Note that the acquisition of the present position information is repeated at predetermined intervals as a process separate from the processes in steps S05 and 06. Namely, the present position information is obtained at any time by the present position information acquiring unit 42. The sequencing unit 43 sequences the information by comparing the present position information which is thus acquired at the predetermined intervals with the plural pieces of position information obtained by the accepting unit 41.

Next, in step S07, the present (real-time) traffic jam information is taken into consideration with respect to the position information sequenced in step S06. To be specific, the sequencing unit 43 takes account of the real-time traffic jam information acquired by the traffic jam information acquiring unit 44, and again sequences the information as the necessity may arise. Namely, the sequencing unit 43 determines, while taking the real-time traffic jam information into consideration, that the sequencing of the position information, which has been executed in step S06, is not adequate, and again sequences the information in a way that takes account of the traffic jam information. Upon completion of the sequencing process taking account of the real-time traffic jam information, the operation proceeds to step S08.

In step S08, the past traffic jam information stored in the traffic jam information storage unit 45 is taken into consideration. To be specific, the sequencing unit 43 further takes account of the past traffic jam information with respect to the sequencing that takes the real-time traffic jam information into consideration, and again sequences the information according to the necessity. For instance, in step S06, the sequencing is done so that the property B is set as the first destination, a route E as the guidance route to the property E is selected even when not particularly crowded according to the present traffic jam information, and, if the guidance to the property is conducted in the afternoon on Saturday, Sunday and holiday (see FIG. 10), the information is re-sequenced by taking the congestion level into consideration. As a result, a sequence such as the property C, the property B, the property A, the property D and the property E is made. Thus, the past traffic jam information as well as the real-time traffic jam information is taken into consideration, thereby enabling the more proper sequencing to be performed without being influenced by the error due to the time lag etc. When completing the sequencing that takes account of the past traffic jam information, the operation proceeds to step S09.

Note that the acquisition of the traffic jam information is repeated at predetermined intervals as a process separate from the processes in steps S05 through S07. Namely, the traffic jam information is acquired in such a way that the traffic jam information acquiring unit 44 obtains the VICS information acquired at intervals of, e.g., 5 minutes. Further, in the first embodiment, the acquired traffic jam information is stored in the traffic jam information storage unit 45 at any time (see FIG. 9). Accordingly, the process of storing the traffic jam information in the traffic jam information storage unit 45, i.e., the process of generating the database exemplified in FIG. 9 may be executed as a process separate from the processes in steps S05 through S07.

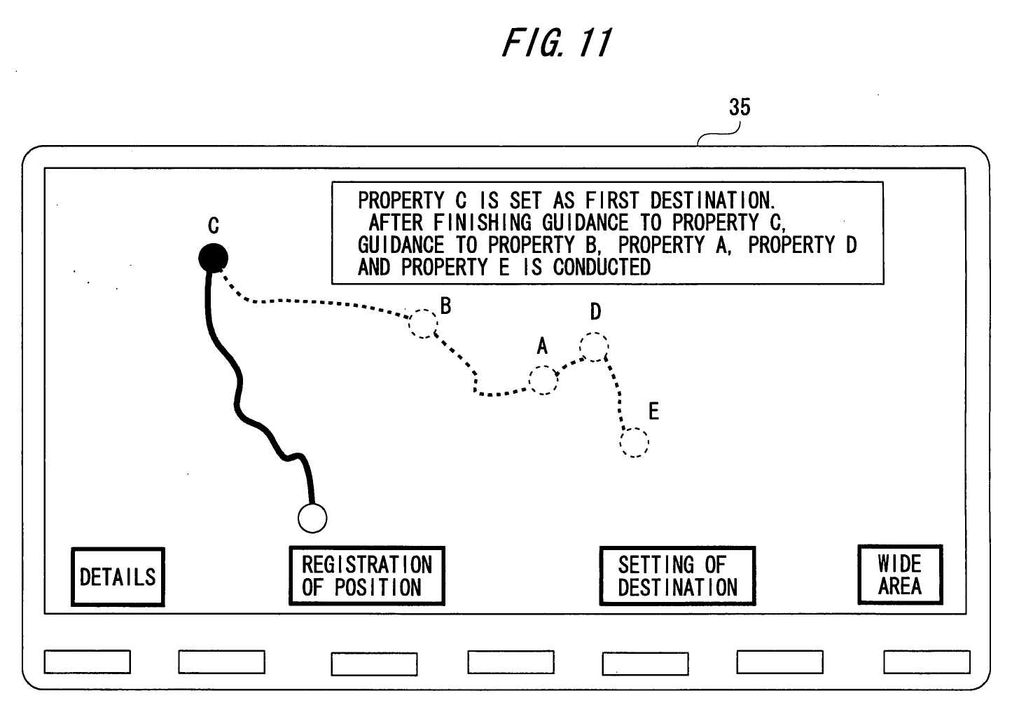

In step S09, the destination is set based on the position information undergoing the execution of the sequencing. For example, in step S08, when sequenced such as the property C, the property B, the property A, the property D and the property E, the destination setting unit 46 sets the first destination to the property C, and then the route guidance is started. When completing the route guidance to the property C, it follows that the route guidance to the property B set as a next destination is started. Incidentally, FIG. 11 illustrates a display status on the display 35 of the navigation equipment 4. A route from the present position to the property C set as the first destination and other properties (the property C, the property B, the property A, the property D and the property E) are displayed on the display 35.

<Effects>

The destination setting system 1 according to the first embodiment discussed above can accept the plural pieces of position information simultaneously from the mobile terminals, and can therefore obviate a time-consuming operation of setting the destination each time. Further, the destination setting system 1 according to the first embodiment sets the (first) destination after sequencing the position information on the basis of the distance from the present position to the destination, eliminates therefore such a necessity that the person himself or herself in charge of sales of the real estate dealer sequences the plural pieces of position information in their priority order, and can reduce an operational burden on the person in charge of sales of the real estate dealer. Accordingly, the sales operations of the real estate dealer can be made more efficient.

It should be noted that the first embodiment discussed above has exemplified the case where the present system is applied to the sales of the real estate dealer, however, the present invention is not limited to this field. The destination setting system can be preferably used for the round of bottling and the sales of the insurance operations. Moreover, for instance, a rental car is mounted with the navigation equipment of the present invention, thereby enabling the navigation equipment to be preferably utilized for a general user to make a tour of resorts. The navigation control device, the navigation equipment and the destination setting system according to the present invention are not limited to those applications but can embrace combinations thereof to the greatest possible degree.

### Second Embodiment

Next, the destination setting system according to a second embodiment will be described. The second embodiment also exemplifies the case in which the destination setting system is applied to the sales operations of the real estate dealer. In the destination setting system according to the second embodiment, unlike the first embodiment, a data processing device 100 installed at a business office generates a property list as a round list (including the plural pieces of position information) of the properties which the person in charge of sales visits round, and transmits this property list to the mobile terminal to the person in charge of sales. Further, the destination setting system according to the second embodiment is characterized mainly in that a server 2a sequences the plural pieces of position information contained in the round list transmitted from the data processing device 100. The following is a specific discussion. Note that the same components as those explained in the first embodiment are marked with the same numerals and symbols, and hence their in-depth descriptions thereof are omitted.

<Architecture>

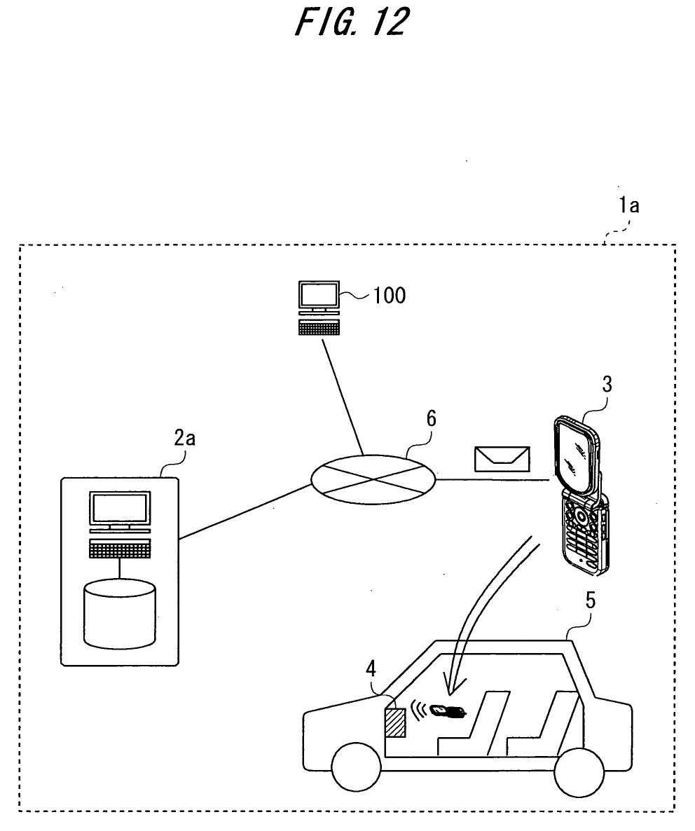

FIG. 12 shows an outline of an architecture of the destination setting system in the second embodiment. As illustrated in FIG. 12, the destination setting system 1a according to the second embodiment is configured by the server 2a, the mobile terminal 3, the navigation equipment 4 mounted in the vehicle 5 and the data processing device 100.

(Data Processing Device)

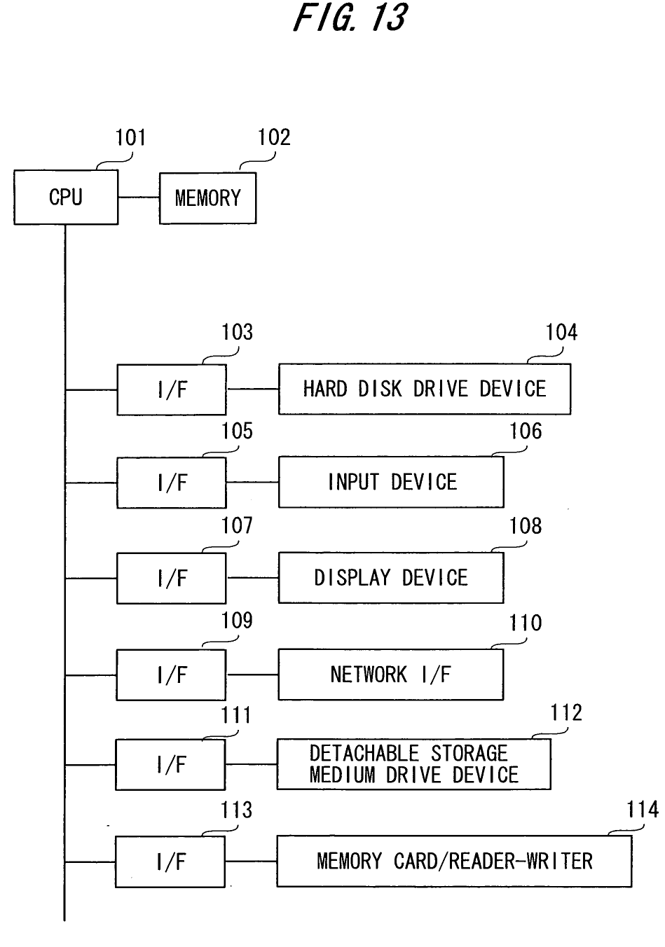

FIG. 13 shows a hardware configuration of the data processing device 100. The data processing device 100 is realized by, e.g., a personal computer and a computer program running on the personal computer. Further, the data processing device 100 may also be realized as a program on the server for providing services to a plurality of personal computers. Still further, the data processing device 100 may also be actualized as a computer system providing functions by linking up the plurality of computers with each other. For example, the data processing device 100 may also be actualized by one or more database servers, one or more simulators and one or more Web servers.

The data processing device 100 according to the second embodiment includes a CPU 101, a memory 102, a variety of interfaces 103, 105, 107, 109, 111, 113, and peripheral devices connected via these interfaces to the CPU 101. FIG. 13 illustrates a hard disk 104, an input device 106, a display device 108, a network interface 110, a detachable storage medium drive device 112 and a memory card/reader-writer 114 by way of examples of the peripheral devices.

The CPU 101 executes the programs developed on the memory 102, thereby providing the functions of the data processing device 100. The memory 102 retains the program in a format enabling the CPU 101 to execute the programs. Further, the memory 102 retains the data processed by the CPU 101. The memory 102 is a DRAM (Dynamic Random Access Memory), a ROM (Read Only Memory) etc. The memory 102 may, however, involve using a flash memory.

The hard disk drive device 104 is stored with the data processed by the CPU 101 accessing the hard disk, the programs executed by the CPU 101, and so on. The input device 106 is exemplified by, e.g., a character input device such as a keyboard and a pointing device such as a mouse. The display device 108 is exemplified by, e.g., a liquid crystal display, an electroluminescence panel, etc.

The network interface 110 is, e.g., a LAN (Local Area Network) board. The detachable storage medium drive device 112 is a drive device such as a CD-ROM, a DVD and a flash memory card. Note that the programs running on the CPU 101 are normally saved on the hard disk via the network interface 110 or the detachable storage medium drive device 112, and are developed on the memory 102. A configuration and an operation of the memory card/reader-writer 114 are the same as those of the card memory interface 17.

(Screen Example of Data Processing Device)

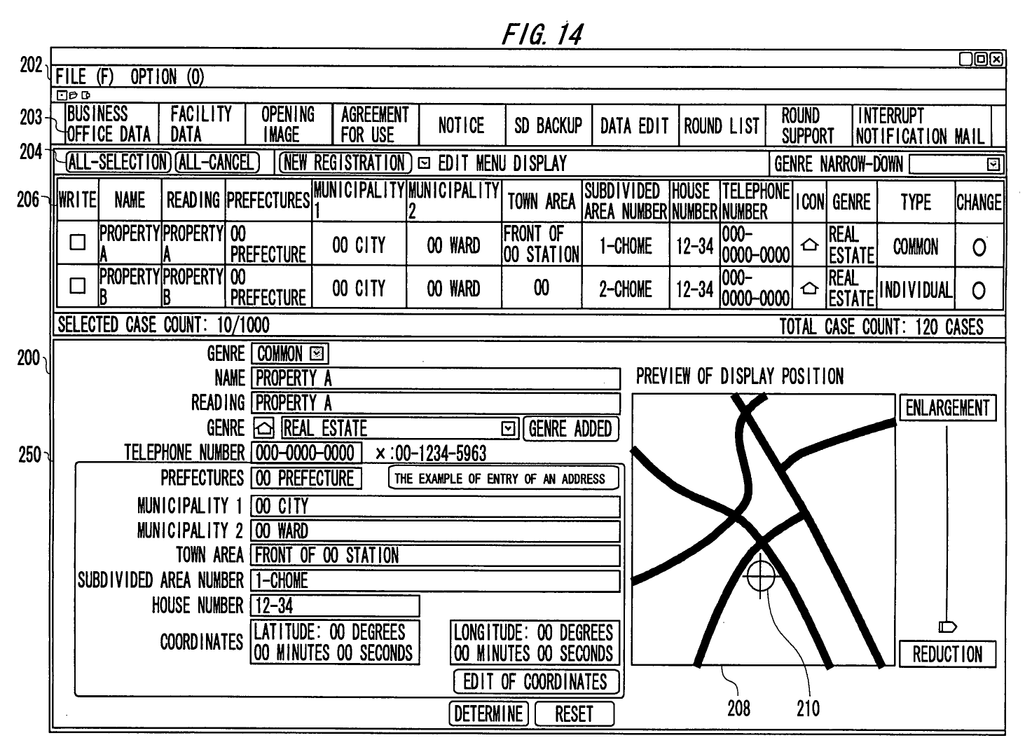

Next, an example of a screen displayed on the navigation equipment 4 by the data processing device 100 will be described. FIG. 14 shows a position information management screen 200 for managing the position information organizing the round list. In FIG. 14, in addition to the position information management screen 200, an edit input screen 250 is displayed under the position information management screen 200.

The position information management screen 200 contains a menu bar 202, a tab display area 203, a list display box (table) 206 and an operation button string 204 for operating the list display box 206. The list display box 206 displays a list of position information managed by the data processing device 100. These items of position information can be inputted by a manual operation from the input device 106 (e.g., the keyboard). Further, the position information can be also inputted to the input data processing device 100 in a CSV (Comma Separated Value) file format from outside via the network interface 110 or the detachable storage medium drive device 112.

As displayed in the list display box 206, the position information according to the second embodiment is organized by fields such as a “write flag” field, a “name” field, a “reading” field, a “prefecture” field, a “municipality 1” field, a “municipality 2” field, a “town area” field, a “subdivided area number” field, a “house number” field, a “telephone number” field, an “icon” field, a “genre” field, a “type” field and a “change” field. Note that a structure of the position information file retained on the hard disk of the data processing device 100 is the same as the structure of the position information displayed in the list display box 206. One row in the list display box (table) 206 represents one record of position information.

In the “write flag” field (a check box is displayed in FIG. 14), it can be designated whether the position information is set as a transmission target information by way of the round list or not. Note that a pull-down menu is displayed from a file menu of the menu bar 202 in a checked status of the write flag, and, when executing a menu item [write to the memory card], the write to the memory card can be done. If the memory card can be inserted into the navigation equipment 4, the position information stored in the memory card can be set as a destination by inserting this memory card into the navigation equipment 4.

A name of the position information is given n the “name” field. The name given in the “name” field is identifying information used for the user to recognize the location. The name given in the “name” field is can be also applied to a name of a facility located at the point concerned. For example, the name is applied to a name of the property called [Property A] and a name of the property called [Property B] (a name of an apartment or a condominium, or a name of the property specified by a name of a constructor). A character string representing the reading of the name in the hiragana syllabary is given in the “reading” field. A prefecture in which the point (location) concerned exists is given in the “prefecture” field. A name of the municipality is set in the “municipality 1” field. A name of a ward, if existing, is given in the “municipality 2” field. A name of a town or district, if existing, is set in the “town area” field. A subdivided area number and an address (house number) are set in the “subdivided area number” field and the “house number” field. If the facility at that point has a telephone, the telephone number is set in the “telephone number” field. The icon is an image symbol (which is also called a graphic object) for displaying the position of the point concerned on the screen. The positions on the map in which the icon is displayed are positions of the longitude and the latitude of the point. When the position information is written to the navigation equipment 4 and when guided along the route up to that point, the destination of the guidance along the route is the position on the map where the icon is displayed. A thumbnail of this image symbol is displayed in the “icon” field in the list display box 206. The image of this icon can be selected from a list of icons provided by the data processing device 100.

The information in the “genre” field is information representing a category of the facility located at the point in the position information. In the second embodiment, the real estate is displayed in the “genre” field, however, the genre may include, e.g., a restaurant, a zoo, an aquarium, a theme park, a convenience store, a golf course, etc. The information in the “type” field shows whether the position information is data utilized in common between organizations or data used for an individual organization. The organization is, for example, one single enterprise. Namely, the [individual] represents the data utilized privately solely for the relevant enterprise. The individual data is exemplified such as a visiting destination of the enterprise, the business office and a return place of the rental car.

Tabs for selecting items of data to be displayed are displayed in the tab display area 203. For instance, business office data can be displayed in the list display box 206 by use of the tab attached with a label of the business office data. Further, facility data can be displayed in the list display box 206 by use of the tab attached with a label of the facility data.

Operation buttons for the items of position information displayed in the list display box 206 are defined in the operation button string 204. An example in FIG. 14 is that the data processing device 100 manages the position information added to the navigation equipment 4 by classifying the position information into the business office data and the facility data. Further, for example, an all-selection button is pressed with the mouse defined as the input device 106, whereby check marks are set in the check boxes of the write flags of all records of position information displayed in the list display box 206. Conversely, all of the check marks are cancelled by pressing an all-cancel button. This scheme enables the round list to be readily generated.

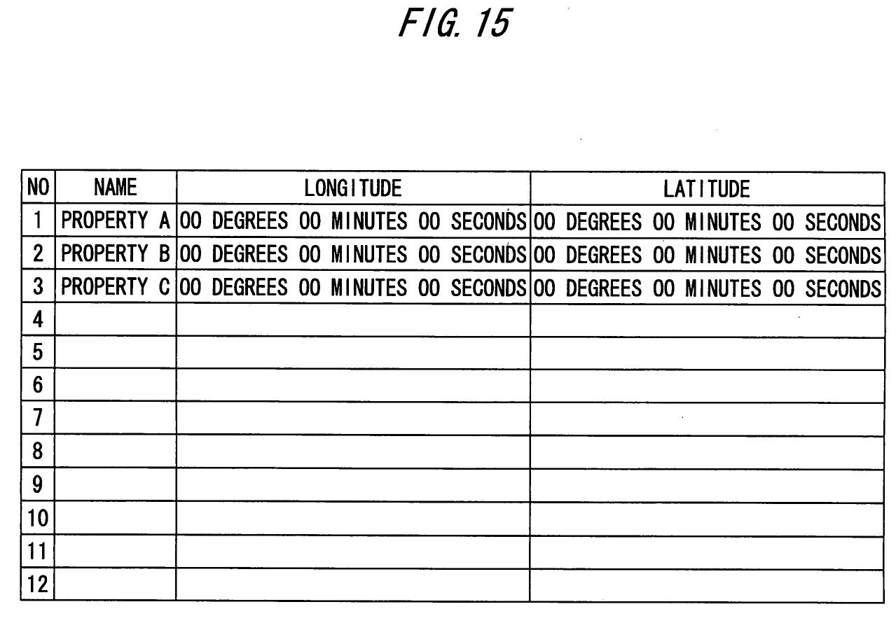

Herein, FIG. 15 shows one example of the round list. According to the data processing device 100, the round list can be generated based on the position information generated by the data processing device 100 or the pre-stored position information. According to the present mode, the round list is organized by the name and the longitude/latitude but may be sufficient if readable by the navigation equipment 4 and may also be organized by telephone numbers etc.

(Server)

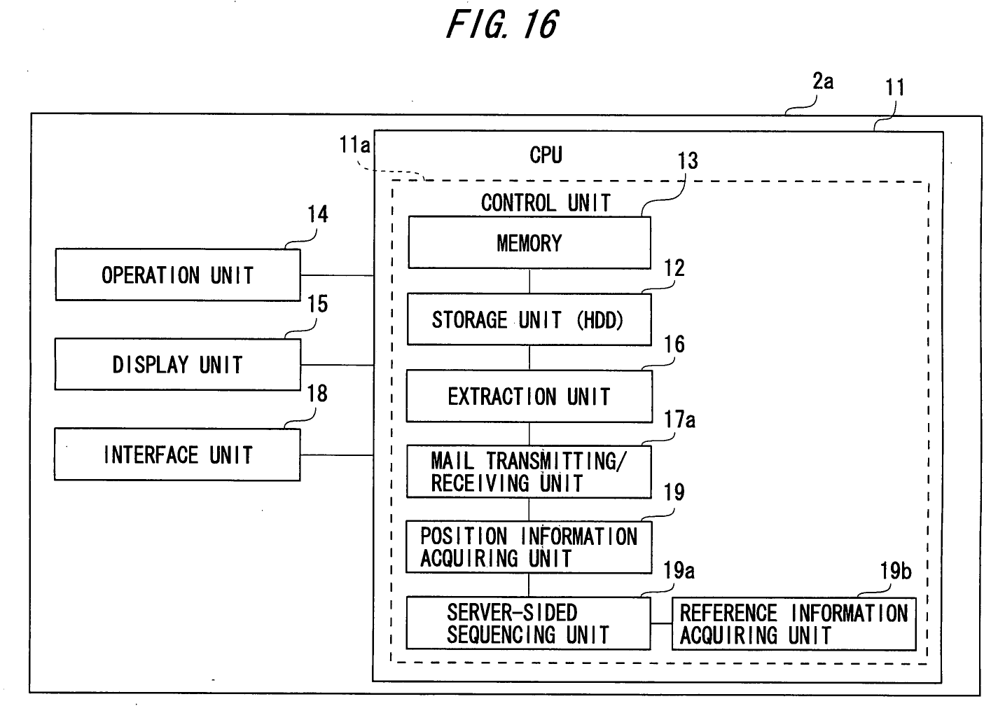

Next, the server according to the second embodiment will be explained. FIG. 16 shows a diagram of function blocks of the server 2a. The server 2a includes the CPU (Central Processing Unit) 11, a control unit 11a, the operation unit 14, the display unit 15 and the interface unit 18. The control unit 11a includes a memory 13, a storage unit (hard disk drive) 12, the extraction unit 16, a mail transmitting/receiving unit 17a, the position information acquiring unit 19, a server-sided sequencing unit 19a and a reference information acquiring unit 19b.

A different point of the server 2a from the server 2 according to the first embodiment will be described. The mail transmitting/receiving unit 17a receives via the interface unit 18 the mail transmitted from the data processing device 100. The position information acquiring unit 19 acquires the plural pieces of position information organizing the round list from the received mail, and stores the position information in the storage unit 12 or the memory 13. In other words, the round list generated and transmitted by the data processing device 100 is stored in the storage unit 12 or the memory 13 of the server 2a. Further, the mail transmitting/receiving unit 17a, when the sequencing process is executed, describes the post-sequencing round list in the mail and thus transmits the mail via the interface unit 18. The mail format is not particularly limited but may take either the text format or the HTML (HyperText Markup Language) format. It should be noted that the mail transmitting/receiving unit 17a and the position information acquiring unit 19 configure server-sided position information acquiring portion according to the present invention.

The server-sided sequencing unit 19a sequences the plural pieces of position information based on the reference information acquired by the reference information acquiring unit 19b which will be described later on. The sequencing process can be done based on the traffic jam information and the required time information taken up to the destination. In the present mode, the plural pieces of position information organizing the round list contained in the mail sent from the data processing device 100 are sequenced, however, the sequencing target information is not restricted to the position information. The server-sided sequencing unit 19a can also sequence the position information extracted by the extraction unit 16. Details of the sequencing process will be explained later on.

(Mobile Terminal/Navigation Equipment)

In the destination setting system 1a according to the second embodiment also, the configurations of the mobile terminal 3 and the navigation equipment 4 are the same as those in the destination setting system according to the first embodiment. Their descriptions are therefore omitted.

<Processing Flow>

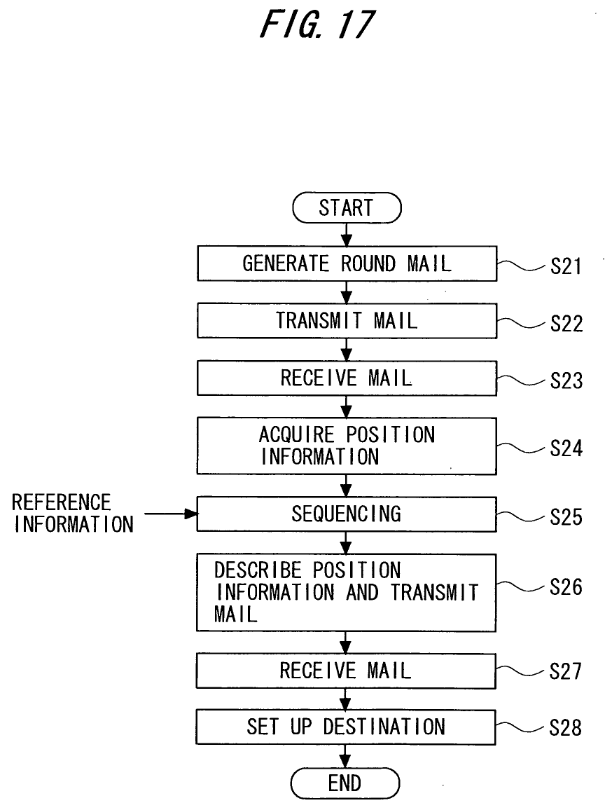

Next, a flow of the destination setting process conducted by the destination setting system 1a according to the second embodiment will be explained. FIG. 17 shows the flow of the destination setting process according to the second embodiment.

In step S21, the round list is generated by use of the data processing device 100. Namely, the person in charge of sales of the real estate dealer or the administrator who allocates the operation to the person in charge of sales generates the round list by operating the input device 106 while observing the screen displayed on the display device 108 of the data processing device 100 (see FIG. 14). Upon completion of generating the round list, the operation proceeds to step S22.

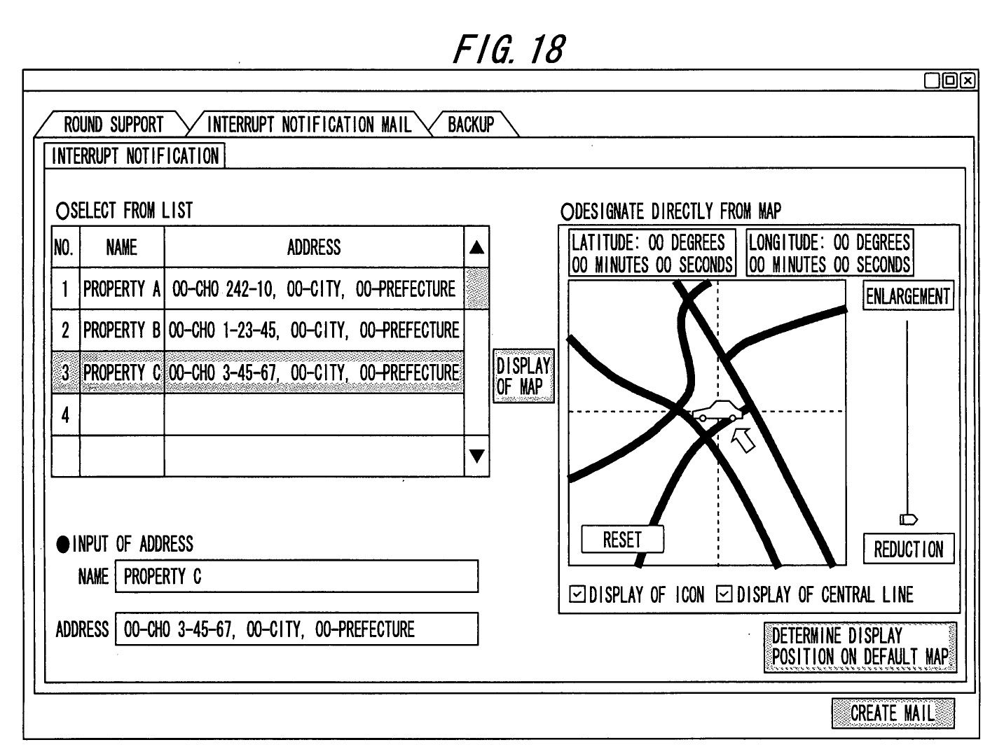

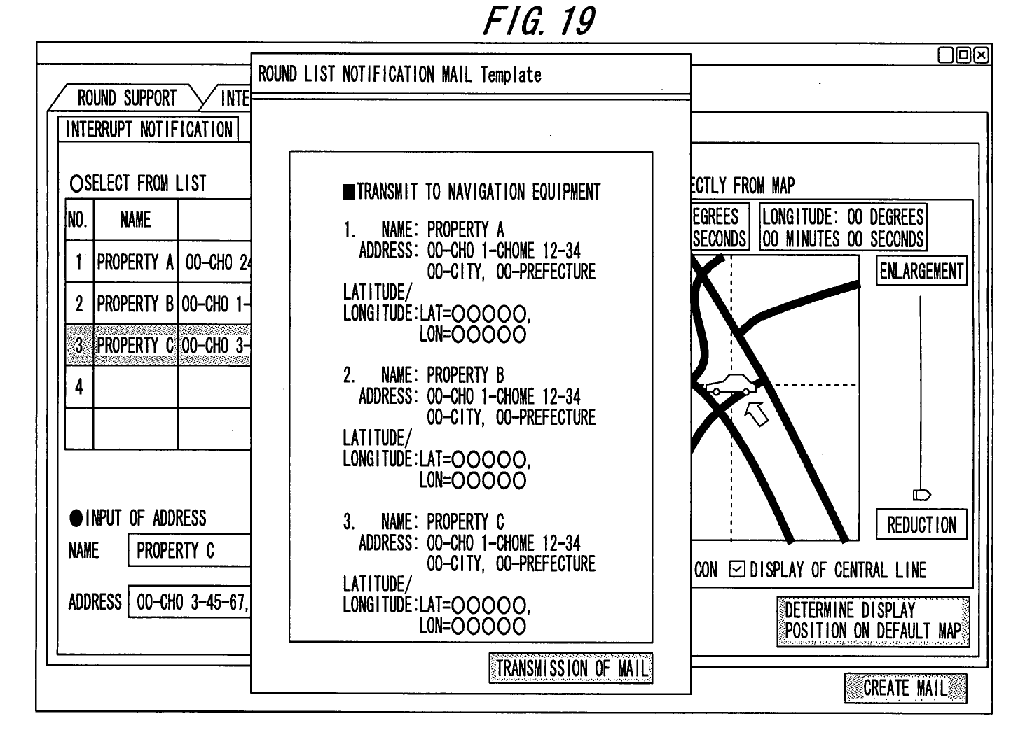

In step S22, the generated round list is transmitted by mail. Namely, the plural pieces of position information (the position information of the real estate in the present mode) are described in the mail and thus transmitted. Herein, FIG. 18 shows one example of a management screen on which the generated round list is described in the mail. When pressing a round list button of the tab display area 203 on a point information management screen 200 (see FIG. 14), the screen is changed over to a screen in FIG. 18. On the screen illustrated in FIG. 18, in addition to the generated round list, a mail creating button is provided. When pressing this mail creating button, the plural pieces of position information organizing the round list are described in the mail. FIG. 19 shows one example of a template of the mail to be transmitted. When pressing the mail creating button on the management screen shown in FIG. 18, a screen illustrated in FIG. 18 starts opening. When pressing a mail transmission button on the screen shown in FIG. 19, the plural pieces of position information described therein are transmitted. Note that the plural pieces of position information (the properties) are sequenced by the creator of the round list (the person in charge of sales or the administrator who allocates the operation to the person in charge of sales) on such an occasion that the data processing device 100 generates the round list in the present mode. To be specific, according to the present mode, the position information is sequenced in the order of the property A, the property B and the property C. Upon completing the transmission of the mail, the operation proceeds to step S23.

In step S23, the mail transmitting/receiving unit 17a of the server 2a receives the mail via the interface unit 18. Namely, the mail transmitting/receiving unit 17a receives the mail containing the round list generated by the data processing device 100. Subsequently in step S24, the position information acquiring unit 19 acquires the plural pieces of position information organizing the round list from the received mail, and the position information is stored in the storage unit 12 or the memory 13. When the acquisition of the position information is completed, the operation proceeds to step S25.

In step S25, the server-sided sequencing unit 19a sequences the plural pieces of position information organizing the round list. To be specific, the server-sided sequencing unit 19a sequences the plural pieces of position information organizing the round list on the basis of the reference information acquired by the reference information acquiring unit 19b. The reference information includes, for example, the traffic jam information about the traffic jams and the required time information about the required time taken up to the destination. The reference information acquiring unit may acquire the reference information by accessing a server for providing the reference information and may also acquire the reference information by getting this information distributed from the server for providing the reference information. In the preset mode, when the data processing device 100 generates the round list, the position information is previously sequenced in the order of the property A, the property B and the property C. For example, if the traffic jam occurs on the route to the property B and if it is more efficient to guide the person in charge of sales to the property C earlier, the server-sided sequencing unit 19a sequences the position information in the order of the property A, the property C and the property B. This contrivance enables the server 2a to sequence the position information in a way that takes account of the unrecognized information (e.g., the traffic jam information etc) when the data processing device 100 generates the round list and the person in charge of sales to go round with the higher efficiency. When the sequencing process is completed, the operation proceeds to step S26.

In step S26, the plural pieces of sequenced position information are described in the mail and thus transmitted. Namely, the server-sided sequencing unit 19a describes the order of the property A, the property C and the property B and the longitudes/latitudes corresponding to these properties in the mail. Note that the items of information described in the mail on this occasion are, in addition to the longitudes/latitudes, a URL (Uniform Resource Locator) in which the property information per person in charge of sales is managed and a command for enabling the longitudes/latitudes and the appointed date information to be transmitted by pressing a transmission button 29 attached to the transmitted mail. When the description in the mail is completed, the plural pieces of position information are transmitted to the mobile terminal 3. When the mail transmission is completed, the operation proceeds to step S27. Incidentally, in the present mode, the items of information are described in the mail by the server-sided sequencing unit 19a and may also be described by the mail transmitting/receiving unit 17a.

In step S27, in the same way as in the first embodiment, the receiving unit 27 of the mobile terminal 3 receives the mail transmitted from the server 2a (which corresponds to step S03 in the first embodiment). When accessing the URL displayed on the screen of the received mail, a Web page is displayed on the display unit 25 of the mobile terminal 3 (see FIG. 6), and the transmission button 29 provided on the Web page is pressed, thereby forwarding the plural pieces of position information displayed on the Web page to the navigation equipment 4 through the infrared-ray communications. When the forwarding of the position information to the navigation equipment 4 is completed, the operation proceeds to step S28.

In step S28, the accepting unit 41 of the navigation equipment 4 obtains the plural pieces of position information (the longitudes/latitudes of the property A, the property C) and the property B and the appointed date information per property through the infrared-ray communications from the mobile terminal 3, which are received by the infrared-ray communication unit 38. Then, the destinations are respectively set in the order of the property A, the property B and the property C. When the setting of the destinations is completed, the route guidance is started.

According to the destination setting system 1a in the second embodiment discussed above, the plural pieces of position information can be accepted simultaneously from the mobile terminal, and it is therefore feasible to obviate a time-consuming operation such as setting the destination each time. Moreover, according to the destination setting system 1a in the second embodiment, the plural pieces of position information organizing the round list generated by the data processing device 100, after being sequenced by the server 2a in the way of taking the traffic jam information etc into consideration, can be set finally as the destinations. Accordingly, the person in charge of sales has no necessity for sequencing by himself or herself priority levels of the plural pieces of position information, and the sales operation of the real estate dealer can be made efficient. Further, the server 2a can obtain much more of the real-time information than the VICS information acquired by the navigation equipment 4, and hence the sales operations can be made more efficient.

It is to be noted that the second embodiment has exemplified the case in which the system is applied to the sales of the real estate dealer, however, the present invention is not limited to this type of operations. The destination setting system can be preferably applied to, e.g., the round of bottling and the sales of the insurance operations.

### Third Embodiment

The destination setting systems according to the first and second embodiments may take the following configuration. For instance, the sequencing process executed by the server 2a according to the second embodiment may also be performed when receiving the query from the mobile terminal 3. To be specific, an instruction of sequencing the position information in the order of the property A, the property B and the property C may be given by accessing the server 2a via the mobile terminal 3. Such a mode according to the third embodiment is useful in a case where the road starts getting into the congestion after starting the route guidance in either the first embodiment or the second embodiment. This is because the navigation equipment 4 can acquire the VICS information, however, there is a time-lag in acquiring the VICS information, and there exists a case in which the server can acquire more of the real-time information.

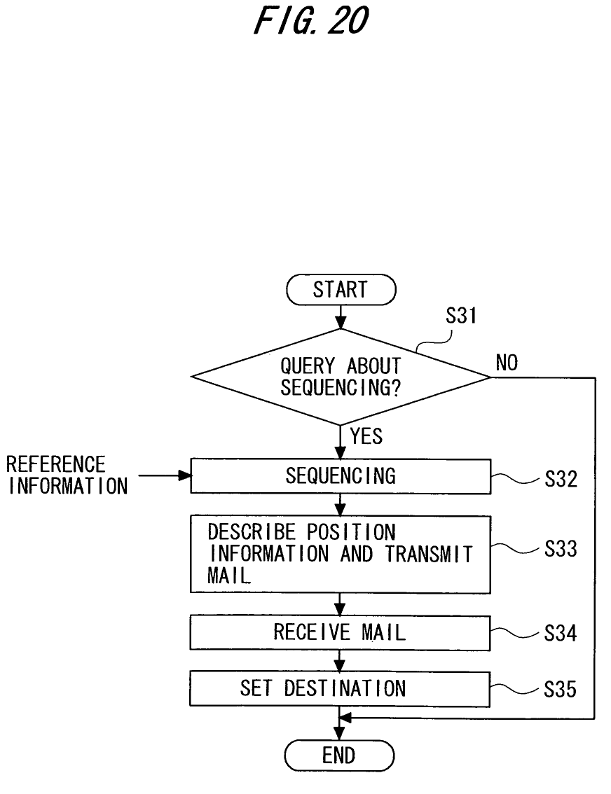

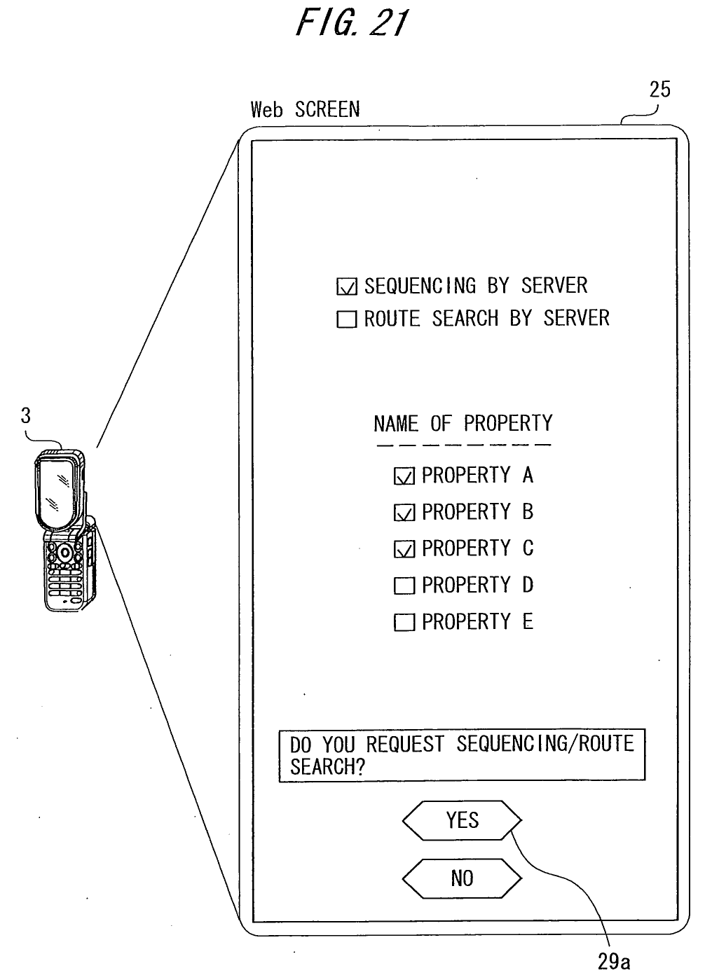

Herein, FIG. 20 shows a flow of the sequencing process in the server in response to the request given from the mobile terminal. In step S31, the server-sided sequencing unit 19a determines whether or not the request (the query about the sequencing) is given from the mobile terminal 3. If the request is given, the operation proceeds to step S32. Whereas if the request is not given, the process is terminated. FIG. 21 illustrates one example of the Web page displayed on the display unit 25 of the mobile terminal 3. On the screen shown in FIG. 21, the plural pieces of position information (the property A, the property B and the property C in the present mode) stored in the storage unit 12 or the memory 13 of the server 2a are displayed, and the check boxes are attached to the respective records of position information, whereby a request target record of position information can be selected. Further, a comment [Do you request a sequencing/route search?] and a transmission button 29a for executing the request are displayed under the position information on the screen illustrated in FIG. 21. The person in charge of sales of the real estate dealer checks the properties displayed on the Web page and, if this content is acceptable, presses the transmission button 29a, whereby the sequencing request can be given to the server 2a. Note that an item [Route search by server] is displayed under an item [Sequencing by server]. The server 2a is provided with the navigation function in addition to the sequencing function, thereby enabling [Route search by server] to be done when selecting this route search button. Incidentally, the sequencing target information may be the information accessible via the mobile terminal 3. Accordingly, the sequencing target information may be the position information organizing the round list generated by the data processing device 100 in the second embodiment and may also be the position information stored beforehand in the server 2 in the first embodiment.

In step S32 (corresponding to step S25 in the processing flow according to the second embodiment), the server-sided sequencing unit 19a sequences the plural pieces of position information organizing the round list on the basis of the reference information acquired by the reference information acquiring unit 19b. In step S33 (corresponding to step S26 in the processing flow according to the second embodiment), the plural pieces of sequenced position information are described in the mail and thus transmitted. Subsequently, in step S34 (corresponding to step S27 in the processing flow according to the second embodiment), the receiving unit 27 of the mobile terminal 3 receives the mail transmitted from the server 2a. Then, in step S35 (corresponding to step S28 in the processing flow according to the second embodiment), the accepting unit 41 of the mobile terminal 3 acquires the plural pieces of position information (the sequenced position information) through the infrared-rays from the mobile terminal 3, which have been received by the infrared-ray communication unit 38. Then, the destinations are set based on the sequenced position information. When the destinations are completely set up, the route guidance is started.

The destination setting system according to the third embodiment enables the server to perform sequencing at its timing when the person in charge of sales of the real estate dealer requires. Accordingly, for example, if the receiving state of the VICS information is unacceptable in the navigation equipment 4, the destinations can be set up in a way that takes account of the real-time information held by the server.

### MODIFIED EXAMPLE

When the data processing device 100 in the destination setting system according to the second embodiment generates the round list, the route may be designated. With this scheme, it is feasible to generate the round list, perform the route guidance based on the generated round list, designate the round sequence and designate the round route.

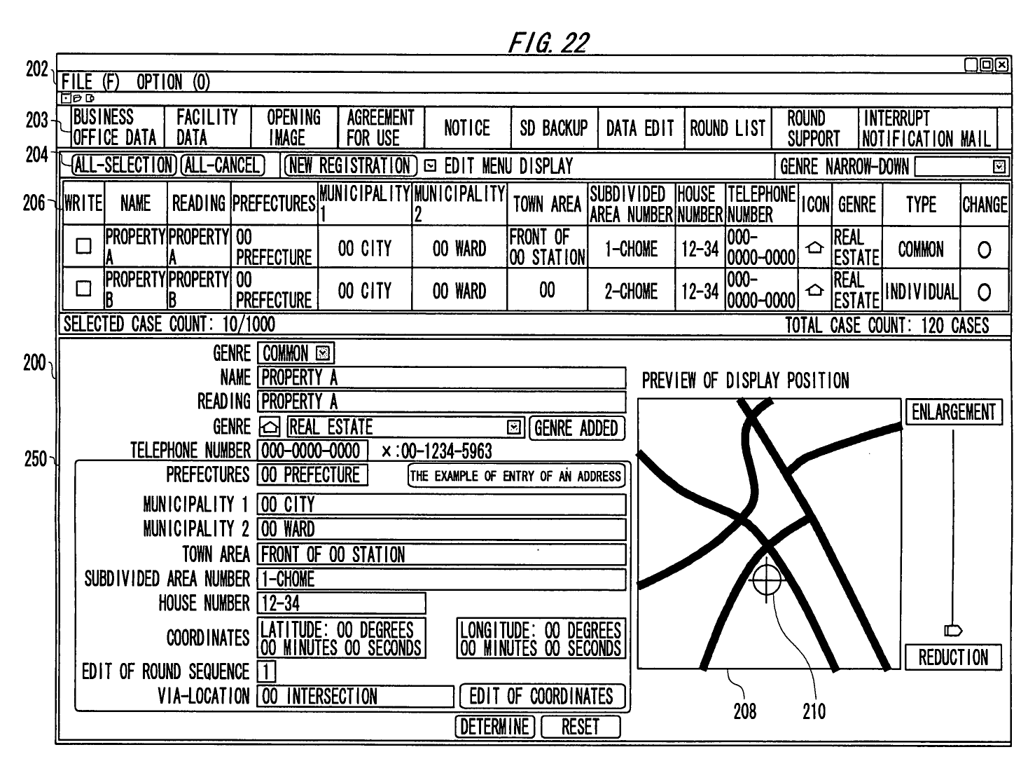

Herein, FIG. 22 shows an example of the position information management screen 200 for managing the position information organizing the round list. Basically, the position information management screen 200 in the present mode is the same as the position information management screen 200 according to the second embodiment but is provided with items related to the round sequence and the via-location on the edit input screen, wherein the round sequence and the via-location can be added and changed. For example, “1” is set in the round sequence for the property A, and “2” is set in the round sequence for the property B, thereby enabling the round sequence for the round destination to be designated. Further, [OO intersection] is designated as the via-location to the property A, whereby a course (route) to the destination can be designated. Namely, according to the mode in the first embodiment, the destination can be set only as the point, however, the present mode enables the course to the destination to be designated as the line. Note that the via-location is sufficient if being the information (e.g., the longitude/latitude information) that can be used when the navigation equipment 1 makes the guidance, and a plurality of via-locations can be set up.

Incidentally, if the via-location is designated as described above, the process of the server 2a may be executed according to the case in which the via-location is not designated, i.e., according to the process explained in the second embodiment. In this case, the via-location is recognized as one item of position information, and the sequencing process may be implemented in a way that takes account of the traffic jam information etc. In this process, however, the route guidance based on the designated route can not be done. Such being the case, the server-sided sequencing unit 19a determines whether there exists the information on the via-location or not and, if there is the via-location, may not change the sequence. With this scheme, the route guidance based on the route designated by the data processing device 100 can be carried out.

The preferred embodiments of the present invention have been discussed, however, the navigation control device, the navigation equipment and the destination setting system according to the present invention are not limited to those embodiments, and the present invention can embrace combinations of those embodiments to the greatest possible degree.

<Others>

The disclosures of Japanese patent application No. JP 2007-269311 filed on Oct. 16, 2007 and Japanese patent application No. JP 2008-253443 filed on Sep. 30, 2008 including the specification, drawings and abstract are incorporated herein by reference.

What is claimed is:

1. A navigation control device, which is mounted in navigation equipment searching for a route and sets a destination from plural pieces of position information forwarded from a mobile terminal, comprising:
accepting portion accepting the plural pieces of position information forwarded from said mobile terminal;
present position information acquiring portion acquiring present position information about a present position of said navigation equipment;
sequencing portion comparing the present position information acquired by said present position information acquiring portion with the plural pieces of position information accepted by said accepting portion, and sequencing the plural pieces of position information on the basis of predetermined conditions including at least any one of a distance from the present position to a destination and time taken from the present position to the destination; and
destination setting portion setting the destination on the basis of the position information sequenced by said sequencing portion.

2. A navigation control device according to claim 1, further comprising: traffic jam information acquiring portion acquiring traffic jam information; and
traffic jam information storage portion stored with the traffic jam information acquired by said traffic jam information acquiring portion,
wherein said sequencing portion sequences the plural pieces of position information in a way that takes account of the real-time traffic jam information acquired by said traffic jam information acquiring portion and the traffic jam information stored in said traffic jam information storage portion.

3. Navigation equipment comprising:
a navigation control unit setting a destination from plural pieces of position information forwarded from a mobile terminal; and
a display unit displaying a route up to a destination set by said navigation control unit,
said navigation control unit including:
accepting portion accepting the plural pieces of position information forwarded from said mobile terminal;
present position information acquiring portion acquiring present position information about a present position of said navigation equipment;
sequencing portion comparing the present position information acquired by said present position information acquiring portion with the plural pieces of position information accepted by said accepting portion, and sequencing the plural pieces of position information on the basis of predetermined conditions including at least any one of a distance from the present position to a destination and time taken from the present position to the destination; and
destination setting portion setting the destination on the basis of the position information sequenced by said sequencing portion.

4. Navigation equipment according to claim 3, wherein said navigation control unit further includes: traffic jam information acquiring portion acquiring traffic jam information; and
traffic jam information storage portion stored with the traffic jam information acquired by said traffic jam information acquiring portion,
wherein said sequencing portion sequences the plural pieces of position information in a way that takes account of the real-time traffic jam information acquired by said traffic jam information acquiring portion and the traffic jam information stored in said traffic jam information storage portion.

5. A destination setting system setting a destination of navigation equipment by forwarding position information contained in information managed by a server to said navigation equipment via a mobile terminal,
said server including:
storage portion containing information previously associated with the position information;
extracting portion extracting plural pieces of predetermined information from the information contained in said storage portion; and
mail transmitting portion describing the plural pieces of predetermined information extracted therefrom in a mail and thus transmitting the mail,
said mobile terminal including:
receiving portion receiving the mail transmitted by said mail transmitting portion; and
forwarding portion forwarding, to said navigation equipment, plural pieces of position information associated with the plural pieces of information described in the mail received by said receiving portion,
said navigation equipment including:
a navigation control unit setting a destination from plural pieces of position information forwarded from a mobile terminal; and
a display unit displaying a route up to a destination set by said navigation control unit,
said navigation control unit including:
accepting portion accepting the plural pieces of position information forwarded from said mobile terminal;
present position information acquiring portion acquiring present position information about a present position of said navigation equipment;
sequencing portion comparing the present position information acquired by said present position information acquiring portion with the plural pieces of position information accepted by said accepting portion, and sequencing the plural pieces of position information on the basis of predetermined conditions including at least any one of a distance from the present position to a destination and time taken from the present position to the destination; and
destination setting portion setting the destination on the basis of the position information sequenced by said sequencing portion.

6. A destination setting system according to claim 5, wherein said navigation control unit further includes: traffic jam information acquiring portion acquiring traffic jam information; and
traffic jam information storage portion stored with the traffic jam information acquired by said traffic jam information acquiring portion,
wherein said sequencing portion sequences the plural pieces of position information in a way that takes account of the real-time traffic jam information acquired by said traffic jam information acquiring portion and the traffic jam information stored in said traffic jam information storage portion.

7. A destination setting system setting a destination of navigation equipment by forwarding position information contained in information managed by a server to said navigation equipment via a mobile terminal,
said server including:
server-sided position information acquiring portion acquiring plural pieces of position information for setting a destination of said navigation equipment;
server-sided sequencing portion sequencing the plural pieces of position information acquired by said server-sided position information acquiring portion; and
mail transmitting portion describing the plural pieces of position information sequenced by said sequencing portion in a mail and thus transmitting the mail to said mobile terminal,
said navigation equipment including:
accepting portion accepting the plural pieces of position information forwarded from said mobile terminal;
destination setting portion setting a destination on the basis of the plurality of position information accepted by said accepting portion and sequenced by said server; and
display portion displaying a route up to the destination set by said destination setting portion.

8. A server in a destination setting system setting a destination of navigation equipment by forwarding position information contained in information managed by a server to said navigation equipment via a mobile terminal, comprising:
server-sided position information acquiring portion acquiring plural pieces of position information for setting a destination of said navigation equipment;
server-sided sequencing portion sequencing the plural pieces of position information acquired by said server-sided position information acquiring portion; and
mail transmitting portion describing the plural pieces of position information sequenced by said sequencing portion in a mail and thus transmitting the mail to said mobile terminal.

9. A server according to claim 8, wherein said server-sided sequencing portion sequences the plural pieces of position information on the basis of sequencing reference information containing at least one of traffic jam information acquired by said server and required time information taken up to the destination.

10. A server according to claim 8, wherein said server-sided sequence changing portion, when a query is given from said mobile terminal, again executes the sequencing process.

11. A server according to any one of claim 8, wherein the position information contains, in addition to the present position information about the present position and the destination information about the destination, via-location information about a via-location.

12. Navigation equipment in a destination setting system setting a destination of navigation equipment by forwarding position information contained in information managed by a server to said navigation equipment via a mobile terminal, comprising:
accepting portion accepting via said mobile terminal the plural pieces of position information described in a mail transmitted from a mail transmitting portion of said server including server-sided position information acquiring portion acquiring plural pieces of position information for setting a destination of said navigation equipment, server-sided sequencing portion sequencing the plural pieces of position information acquired by said server-sided position information acquiring portion, and said mail transmitting portion describing the plural pieces of position information sequenced by said sequencing portion in a mail and thus transmitting the mail to said mobile terminal;
destination setting portion setting a destination on the basis of the plurality of position information accepted by said accepting portion and sequenced by said server; and
display portion displaying a route up to the destination set by said destination setting portion.
